(19) United States
(12) Patent Application Publication
(10) Pub. No.: US 2014/0279146 A1
(43) Pub. Date: Sep. 18, 2014

(54) PRESENTING CONTENT AS A RESULT, AT LEAST IN PART, TO RELAYING OF A BID AND FOLLOWING LAPSE OF A SPECIFIC AMOUNT OF CONTENT ACCESS LATENCY

(71) Applicant: Elwha LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(21) Appl. No.: 13/905,839

(22) Filed: May 30, 2013

Related U.S. Application Data
(63) Continuation-in-part of application No. 13/795,612, filed on Mar. 12, 2013.
Application No. 13/795,612 is a continuation-in-part of application No. 13/854,203, filed on Apr. 1, 2013.
Application No. 13/854,203 is a continuation of application No. 13/853,706, filed on Mar. 29, 2013.
Application No. 13/853,706 is a continuation-in-part of application No. 13/859,061, filed on Apr. 9, 2013.
Application No. 13/859,061 is a continuation of application No. 13/858,656, filed on Apr. 8, 2013.
Application No. 13/858,656 is a continuation-in-part of application No. 13/868,335, filed on Apr. 23, 2013.
Application No. 13/868,335 is a continuation of application No. 13/867,313, filed on Apr. 22, 2013.
Application No. 13/867,313 is a continuation-in-part of application No. 13/894,625, filed on May 15, 2013.
Application No. 13/894,625 is a continuation of application No. 13/893,879, filed on May 14, 2013.

(51) Int. Cl. G06Q 30/08

(52) U.S. Cl. CPC G06Q 30/08
USPC 705/26.3

(57) ABSTRACT

Computationally implemented methods and systems include presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency: relaying the bid in response, at least in part, to obtaining the bid as a result of the soliciting, the bid to be relayed indicating at least the user elected fee amount; acquiring at least access to the content as a result, at least in part, of the relaying; and presenting at least the access to the content following lapse of the specific amount of content access latency. In addition to the foregoing, other aspects are described in the claims, drawings, and text.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 13/795,612, entitled TIERED LATENCY OF ACCESS FOR CONTENT, naming Roderick A. Hyde; Royce A. Levien; Richard T. Lord; Robert W. Lord; Mark A. Malamud; Tony S. Pan; Lowell L. Wood, Jr. as inventors, filed 12 Mar., 2013 with attorney docket no. 0912-003-001-000000, which is currently co-pending or is an application of which a currently co-pending application is entitled to the benefit of the filing date.

The present application constitutes a continuation-in-part of U.S. patent application Ser. No. 13/854,203, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 1 Apr., 2013 with attorney docket no. 0912-003-002-000001, which is currently co-pending or is an application of which a currently co-pending application is entitled to the benefit of the filing date, and which is a continuation of U.S. patent application Ser. No. 13/853,706, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 29 Mar., 2013 with attorney docket no. 0912-003-002-000000.

The present application constitutes a continuation-in-part of U.S. patent application Ser. No. 13/859,061, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 9 Apr., 2013 with attorney docket no. 0912-003-003-000001, which is currently co-pending or is an application of which a currently co-pending application is entitled to the benefit of the filing date, and which is a continuation of U.S. patent application Ser. No. 13/858,656, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 8 Apr., 2013 with attorney docket no. 0912-003-003-000000.

The present application constitutes a continuation-in-part of U.S. patent application Ser. No. 13/868,335, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 23 Apr., 2013 with attorney docket no. 0912-003-008-000000, which is currently co-pending or is an application of which a currently co-pending application is entitled to the benefit of the filing date, and which is a continuation of U.S. patent application Ser. No. 13/867,313, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 22 Apr., 2013 with attorney docket no. 0912-003-004-000000.

The present application constitutes a continuation-in-part of U.S. patent application Ser. No. 13/894,625, entitled ELICITING ONE OR MORE BIDS FOR ACCESSING CONTENT AT ONE OR MORE LEVELS OF CONTENT ACCESS FROM TWO OR MORE CLIENT COMPUTING DEVICES, naming Roderick A. Hyde; Royce A. Levien; Richard T. Lord; Robert W. Lord; Mark A. Malamud; Tony S. Pan; Lowell L. Wood, Jr. as inventors, filed 15 May, 2013 with attorney docket no. 0912-003-009-000000, which is currently co-pending or is an application of which a currently co-pending application is entitled to the benefit of the filing date, and which is a continuation of U.S. patent application Ser. No. 13/893,879, entitled ELICITING ONE OR MORE BIDS FOR ACCESSING CONTENT AT ONE OR MORE LEVELS OF CONTENT ACCESS FROM TWO OR MORE CLIENT COMPUTING DEVICES, naming Roderick A. Hyde; Royce A. Levien; Richard T. Lord; Robert W. Lord; Mark A. Malamud; Tony S. Pan; Lowell L. Wood, Jr. as inventors, filed 14 May, 2013 with attorney docket no. 0912-003-005-000000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).
If the listings of applications provided above are inconsistent with the listings provided via an ADS, it is the intent of the Applicant to claim priority to each application that appears in the Priority Applications section of the ADS and to each application that appears in the Priority Applications section of this application.
All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### SUMMARY

In one or more various aspects, a method includes, but is not limited to, presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency, relaying the bid in response, at least in part, to obtaining the bid as a result of the soliciting, the bid to be relayed indicating at least the user elected fee amount; acquiring at least access to the content as a result, at least in part, of the relaying; and presenting at least the access to the content following lapse of the specific amount of content access latency. In some implementations, at least one of the registering, detecting, or displaying being performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency; means for relaying the bid in response, at least in part, to obtaining the bid as a result of the soliciting, the bid to be relayed indicating at least the user elected fee amount, means for acquiring at least access to the content as a result, at least in part, of the relaying; and means for presenting at least the access to the content following lapse of the specific amount of content access latency. In addition to the foregoing, other system aspects are described in the claims, drawings, and text forming a part of the disclosure set forth herein.

In one or more various aspects, a system includes, but is not limited to, circuitry for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency, circuitry for relaying the bid in response, at least in part, to obtaining the bid as a result of the soliciting, the bid to be relayed indicating at least the user elected fee amount; circuitry for acquiring at least access to the content as a result, at least in part, of the relaying; and circuitry for presenting at least the access to the content following lapse of the specific amount of content access latency. In addition to the foregoing, other system aspects are described in the claims, drawings, and text forming a part of the disclosure set forth herein.

In one or more various aspects, a computer program product, comprising a signal bearing non-transitory storage medium bearing one or more instructions including, but not limited to, presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency, relaying the bid in response, at least in part, to obtaining the bid as a result of the soliciting, the bid to be relayed indicating at least the user elected fee amount; acquiring at least access to the content as a result, at least in part, of the relaying; and presenting at least the access to the content following lapse of the specific amount of content access latency. In addition to the foregoing, other computer program product aspects are described in the claims, drawings, and text forming a part of the disclosure set forth herein.

In one or more various aspects, a system includes, but is not limited to an interface providing module configured to provide an interface for eliciting a bid from a user for accessing a content with a specific amount of content access latency, the bid to be elicited being defined by at least one user elected fee amount elected from a plurality of fee amounts available for election for the specific amount of content access latency, the user elected fee amount being an amount of fee being offered through the bid in exchange for accessing the content following lapse of the specific amount of content access latency; a bid obtaining module configured to obtain the bid as a result, at least in part, of the providing of the interface; a bid transmitting module configured to transmit the bid in response, at least in part, to obtaining the bid, the bid to be transmitted defining at least the user elected fee amount; a content access obtaining module configured to obtain at least access to the content as a result, at least in part, of the transmitting; and a content access providing module configured to provide at least the access to the content following lapse of the specific amount of content access latency.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of a computing device operating in a network environment.

FIGS. 2A, 2B, 2C, 2D, 2E, 2F, 2G, 2H, 2I, 2K, and 2M show exemplary graphical user interfaces (GUIs) that may be displayed by the computing device 10* of FIG. 1.

FIG. 3A shows a block diagram of particular implementation of the computing device 10* of FIG. 1.

FIG. 3B shows a block diagram of another implementation of the computing device 10* of FIG. 1

FIG. 4A shows another perspective of the interface providing module 102* of FIGS. 3A and 3B (e.g., the interface providing module 102′ of FIG. 3A or the interface providing module 102″ of FIG. 3B) in accordance with various implementations.

FIG. 4B shows the content access obtaining module 106* of FIGS. 3A and 3B (e.g., the content access obtaining module 106′ of FIG. 3A or the content access obtaining module 106″ of FIG. 3B) in accordance with various implementations.

FIG. 4C shows the content access providing module 108* of FIGS. 3A and 3B (e.g., the content access providing module 108′ of FIG. 3A or the content access providing module 108″ of FIG. 3B) in accordance with various implementations.

FIG. 5 is a high-level logic flowchart of a process, e.g., operational flow 500, according to some embodiments.

FIG. 6A is a high-level logic flowchart of a process depicting alternate implementations of the interface presenting operation 502 of FIG. 5.

FIG. 6B is a high-level logic flowchart of a process depicting alternate implementations of the interface presenting operation 502 of FIG. 5.

FIG. 6C is a high-level logic flowchart of a process depicting alternate implementations of the interface presenting operation 502 of FIG. 5.

FIG. 6D is a high-level logic flowchart of a process depicting alternate implementations of the interface presenting operation 502 of FIG. 5.

FIG. 6E is a high-level logic flowchart of a process depicting alternate implementations of the interface presenting operation 502 of FIG. 5.

FIG. 6F is a high-level logic flowchart of a process depicting alternate implementations of the interface presenting operation 502 of FIG. 5.

FIG. 6G is a high-level logic flowchart of a process depicting alternate implementations of the interface presenting operation 502 of FIG. 5.

FIG. 7A is a high-level logic flowchart of a process depicting alternate implementations of the bid relaying operation 504 of FIG. 5.

FIG. 7B is a high-level logic flowchart of a process depicting alternate implementations of the bid relaying operation 504 of FIG. 5.

FIG. 7C is a high-level logic flowchart of a process depicting alternate implementations of the bid relaying operation 504 of FIG. 5.

FIG. 8A is a high-level logic flowchart of a process depicting alternate implementations of the content access acquiring operation 506 of FIG. 5.

FIG. 8B is a high-level logic flowchart of a process depicting alternate implementations of the content access acquiring operation 506 of FIG. 5.

FIG. 9A is a high-level logic flowchart of a process depicting alternate implementations of the content access presenting operation 508 of FIG. 5.

FIG. 9B is a high-level logic flowchart of a process depicting alternate implementations of the content access presenting operation 508 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

In recent years, the rapid development of computing and networking technologies has fueled explosive growth in demand for content. The word “content” for purposes of this description may be in reference to any one or more of a wide variety of data/information that may be made available through today's computing and/or networking technologies. Some examples of content include news (e.g., business or financial news such as stock or commodities prices, celebrity news, agricultural news, regulatory and/or governmental news, sports news, and so forth), information provided through social media, consumable media such as movies, soundtracks, sporting events, and so forth.

As these technologies continue to evolve, consumers of such content (e.g., content consumers or simply “users”) are also demanding earlier and more timely access to content. For example, consumers of content in the financial and commodity industries are demanding increasingly earlier and earlier access to content (e.g., financial or market data such as stock or commodity prices). That is, early knowledge of certain financial/market/commodity information by, for example, institutional content consumers (e.g., banks, brokerage firms, etc.) may provide huge advantages for those institutional content consumers. Similarly, many everyday consumers of consumable media (e.g., movies, sports program, audio recordings, etc.) have a strong desire to access such consumable media as soon as such media becomes available.

It is also recognized that while some users (i.e., content consumers) are willing to pay a large premium for accessing content early, other users may not be as willing to pay such a high premium for early access to the same content. It is further recognized that different users will have different needs as to how soon they would like to access content and how much of a premium they would be willing to pay in order to get such early access to the content. Accordingly, computationally-implemented systems and methods are provided herein that allow a user to get earlier access to content by paying a higher fee. That is, the computational-implemented systems and methods to be described herein allow a user to submit a bid to a content source (e.g., a content provider) for accessing a content following lapse of a specific amount of content access latency, the bid to be submitted defining at least one user elected fee amount elected from a plurality of (defined or undefined) fee amounts available for election for the specific amount of content access latency, the user elected fee amount being an amount of fee being offered through the bid in exchange for accessing the content following lapse of the specific amount of content access latency. From another perspective, the bid that may be submitted by the user may be a bid for the specific amount of content access latency rather than simply for accessing the content. The systems and methods may then be designed to provide the content following acceptance of the bid by, for example, the content source and following lapse of the specific amount of the content access latency. In various implementations, the computational-implemented systems and methods may be implemented at a client device (e.g., an end user computer device such as a desktop, a workstation, a laptop, a mobile device such as a Smartphone or a tablet computer, an electronic trading platform such as Bloomberg terminal, and so forth).

Turning now to FIG. 1, which illustrates an example environment 100 in which the methods, systems, circuitry, and computer program products in accordance with various embodiments may be implemented at a computing device 10*. The computing device 10* may have any one of a variety of form factors including, for example, a mobile computing device (e.g., a smartphone, a tablet computer, a laptop, and so forth), a desktop computer, a workstation, a dedicated terminal such as an electronic trading platform (e.g., Bloomberg terminal), and so forth. Note that FIGS. 3A and 3B illustrate block diagrams of two alternative implementations of the computing device 10* of FIG. 1. Note further that in the following, “*” represents a wildcard. Thus, references in the following description to, for example, “computing device 10*” may be in reference to the computing device 10* of FIG. 1 as well as the computing device 10′ of FIG. 3A or the computing device 10″ of FIG. 3B.

In various embodiments, the computing device 10* may electronically communicate with one or more content sources 60 (e.g., one or more content providers) via one or more wireless and/or wired networks 5. A content source 60 may be any entity that can be the source for content 20. Examples of a content source 60 include, for example, Dow Jones, Nasdaq, Associated Press, Reuters, Bloomberg, New York Times, Twitter (e.g., a celebrity who uses Twitter or other social media such as Facebook, or a layperson providing any information of interest through social media), police or fire department communication channels, HBO, Warner Brothers, Columbia Pictures, NBC, Universal, Walt Disney, and so forth.

In some embodiments, the computing device 10* may be designed to receive one or more bidding tags 30 from one or more content sources 60. For these embodiments, a bidding tag 30 may be transmitted by a content source 60 to the computing device 10* (as well as to other users 50) in order to elicit at least one bid 40 from a user 12 through the computing device 10* (as well as to elicit one or more bids 40 from one or more other users 50). That is, in some cases, when a bidding tag 30 is received by the computing device 10*, the computing device 10* may be prompted to present an interface (e.g., a GUI 200a, 200b, 200c, or 200d of FIG. 2A, 2B, 2C, or 2D) for soliciting at least the one bid 40. In various embodiments, the bidding tag 30 that may be transmitted to the computing device 10* may provide generic information related to a particular content 20 that is being offered for consumption. For example, in some cases, the bidding tag 30 may contain just enough information about the particular content 20 to make the particular content 20 identifiable (e.g., identifiable as a particular type of news or a particular movie) but without providing or disclosing core component or components of the particular content 20 (e.g., core component of the content 20 that if revealed would render the particular content 20 essentially worthless). For example, if the particular content 20 being offered for consumption is a movie, then the corresponding bidding tag 30 may include at least the title of the movie, and in some cases, additional data such as names of the cast and/or crew, movie trailer or trailers, and so forth. Further, the corresponding bidding tag 30 would generally not include the entire movie itself.

If the particular content 20 being offered for consumption is, on the other hand, financial or market news, then the corresponding bidding tag 30 may merely identify the type of financial/market news (e.g., identifying the content 20 as “share price of ACME common stocks on Jan. 21, 2016”) that is included in the content 20 without providing essential information (e.g., without providing the actual share price) related to the financial/market news. In yet another example, if the particular content 20 being offered for consumption is news related to a particular celebrity, than the corresponding bidding tag 30 may indicate that the content 20 is “celebrity news” or may indicate the name of the celebrity without indicating what the news related to the celebrity is all about (e.g., the bidding tag 30 may indicate that the content 20 is news about “Lindsey Lohan” without identifying the specific news related to Lindsey Lohan). Thus, in various implementations, a bidding tag 30 for a particular content 20 to be offered for consumption may provide certain generic information related to the particular content 20 without providing core or essential data related to the particular content 20.

In response, at least in part, to receiving a bidding tag 30, the computing device 10* may be designed to provide an interface (e.g., a channel) for eliciting (e.g., soliciting) from a user 12 at least one bid 40 that indicates at least a user elected fee amount that the user 12 is offering to pay through the bid 40 in exchange for being allowed to access the particular content 20 with a specific amount of content access latency. In some cases, the specific amount of content access latency that is being bid on may also be elected (e.g., inputted or defined) by the user 12.

In various embodiments, the interface that may be presented by the computing device 10* for eliciting at least one bid 40 may be an audio and/or visual interface. In cases where a visual interface is presented by the computing device 10*, the presented visual interface may be in the form of a graphical user interface (GUI) for eliciting and then submitting, by a user 12, of at least one bid 40 for accessing a particular content 20 with a specific amount of content access latency. In various embodiments, a bid 40 that may be submitted by a user 12 may include or may be defined by at least one user elected fee amount that the user 12 is offering to pay in exchange for accessing the particular content 20 with the specific amount of content access latency. That is, and from another perspective, the bid 40 that may be submitted by the user 12 may be an offer to pay a user specified fee amount in exchange for accessing a content 20 with a specific amount of content access latency rather than simply for accessing the content 20. In some embodiments, the bid 40 that is submitted may also define the specific amount of content access latency, which may also have been elected by the user 12. Note that in some cases, a user 12 may submit multiple bids 40 for accessing the particular content 20 with multiple content access latencies. A user 12 may wish to submit multiple bids 40 if, for example, an initial bid can be rejected or denied by the content source 60 in which case a secondary bid may serve as a backup bid.

In some embodiments, the GUI that may be presented by the computing device 10* for soliciting/submitting the one or more bids 40 may actually elicit from a user 12 a user elected fee amount and/or a user elected amount of content access latency. That is, a bid 40 that is elicited (e.g., solicited) from a user 12 may be defined by at least a user elected fee amount, and in some cases, a user elected content access latency. Note that examples of exemplary GUIs that may be presented by the computing device 10* of FIG. 1 for soliciting/submitting one or more bids 40 are illustrated in FIGS. 2A, 2B, 2C, 2D, 2E, 2F, 2G, 2H, 2I, 2K, and 2M and which will be discussed in greater detail herein.

In some cases the word “latency” may be in reference to an increment or interval of time between some arbitrary point in time and the point in time that a particular content 20 is actually released to one or more users (e.g., user 12 and one or more other users 50). In some cases, the arbitrary point in time may be the earliest point in time that a particular content 20 is available for consumption. For example, in the case where the particular content 20 includes a feature length movie, the related latency may be the amount of time between when the movie is initially released in theaters and the point in time that the movie is made available. In the case where the particular content 20 relates to the price of a particular stock, the related latency may be the amount of time between when the price is first available through Dow Jones or Nasdaq and when the price is actually made accessible or released. In various implementations, the point in time in which the “latency clock” begins may not be relevant since the point in time that the latency clock begins can be completely arbitrary. That is, the phrase “latency” as used herein relates to a time increment or interval. Thus, a more relevant aspect in accordance with these implementations may be the amount of user elected fee amount that a user 12 is offering/chooses to pay in exchange for being able to access a particular content 20 with a specific/specified amount of content access latency.

In response to the presentation of a GUI for soliciting/eliciting one or more bids 40 by the computing device 10* a user 12 may elect at least one user elected fee amount that the user 12 is offering to pay in exchange for accessing the content 20 with a specific amount of content access latency. As will be further described herein, there are at least two ways that a user 12 may “elect” a user elected fee amount, the first way is for the user 12 to enter the user elected fee amount (see GUI 200a of FIG. 2A and feature 202a for inputting the fee amount) and the second way is for the user 12 to select the user elected fee amount from a plurality of predefined and varying (e.g., tiered) fee amounts (see GUI 200c of FIG. 2C, and feature 202c for selecting an elected fee amount from a plurality of indicated fee amounts). Note that in the case where the user 12 “enters” the user elected fee amount rather than selecting the user elected fee amount from a plurality of indicated fee amounts, the user 12 is still electing the user elected fee amount from a plurality of fee amounts—it is just that the user 12 is electing the user elected fee amount from a plurality of undefined fee amounts. In some embodiments, the GUI that is presented may also be used by the user 12 to elect a specific amount of content access latency in addition to being used for electing the at least one user elected fee amount.

As a result of presenting the interface (e.g., a GUI 200a, 200b, 200c, or 200d of FIG. 2A, 2B, 2C, or 2D) for soliciting/eliciting at least one bid 40 for accessing the particular content 20, the computing device 10* may be designed to accept (obtain) from a user 12 at least one user elected fee amount (as well as in some cases, at least one user elected amount of content access latency). In response to obtaining the at least one user elected fee amount from the user 12, the computing device 10* may transmit at least one bid 40 to the content source 60 via the one or more wireless and/or wired networks 5. In response to receiving the at least one bid 40 from the computing device 10* as well as receiving one or more bids 40 from other users 50, the content source 60 may release the content 20 to the computing device 10* as well as to one or more other users 50 in accordance with one or more received bids 40.

In some embodiments, access to the content 20 may be provided by the content source 60 to the computing device 10* after the content source 60 has accepted/granted the at least one bid 40 submitted by the computing device 10*. The access to the content 20 that may be provided to the computing device 10* may be provided only after the specific amount of content access latency, which was bid on through the at least one bid 40, has lapsed. In other implementations, the access to the content 20 may be provided to the computing device 10* prior to the specific amount of content access latency lapsing. In such situations, the computing device 10* may withhold access to the content 20, at least temporarily, and not release the access to the content 20 (e.g., not audibly and/or visually present the received content 20) until the specific amount of content access latency has lapsed.

In some embodiments, the computing device 10*, in addition to being able to acquire and present a particular content 20 may also be designed to acquire and present previous consumer information 22 and/or contextual data 24 associated with the particular content 20. The previous consumer information 22 that may be acquired and presented by the computing device 10* may provide various information related to other users 50 who may have previously viewed the particular content 20. For example, if user 12 elects to receive a specific content 20 (e.g., content 20 that is related to the price of a particular stock on a particular date) one second (e.g., one second latency) following the initial release of the specific content 20, then the computing device 10* may be designed to receive previous consumer information 22 that indicates, for example, how many other users 50 have already previously accessed the specific content 20, the identities of those other users 50 who have already accessed the specific content 20, and/or how those other users 50 may have previously viewed the specific content 20 (e.g., the communication channels such as bandwidth of the communication channels that were used by the other content consumers in order to access the specific content 20). In some cases, such information may prove valuable to a user 12 (e.g., an institutional user such as a brokerage firm) receiving the content 20 when, for example, the user 12 is making business/financial decisions. In some embodiments, the computing device 10* may be configured to present the previous consumer information 22 to the user 12 before the user 12 submits a bid 40 for accessing the specific content 20 with the specific amount of content access latency, while in other embodiments, the computing device 10* may be configured to present the previous consumer information 22 when the content 20 is presented to the user 12.

As indicated above, in some implementations, the computing device 10* may be designed to acquire and present contextual data 24 in addition to being designed to acquire and present content 20. In various embodiments, contextual data 24 is data that is related to a particular content 20 and that may supplement the related content 20. For example, if a specific content 20 that is to be acquired and presented by the computing device 10* is financial/market news (e.g., price of a particular stock or commodity on a particular date) then the computing device 10* may be further designed to acquire and present a corresponding contextual data 24 that provide historical financial/market data (e.g., historical prices of the particular stock or commodity). On the other hand, if the content 20 that is to be received by the computing device 10* is a consumable media such as a feature length movie, then the contextual data 24 that may be acquired and presented by the computing device 10* may be one or more movie trailers that may be trailers for the movie or for another movie (e.g., another movie in the same genre). A more detailed discussion related to various aspects of the exemplary environment of FIG. 1 will be provided with respect to the processes and operations to be described herein.

Referring now to FIGS. 2A, 2B, 2C, 2D, 2E, 2F, 2G, 2H, 2I, 2K, and 2M, which illustrate exemplary selection GUIs that may be presented by the computing device 10* of FIG. 1 in order to elicit one or more bids 40 from a user 12. In various embodiments, the exemplary GUIs may be for electing at least one user elected fee amount for an accessing content 20 with a specific amount of content access latency.

Turning particularly now to FIG. 2A, which illustrated an exemplary GUI 200a for soliciting/eliciting at least one bid 40 from a user 12 for accessing a particular content 20 with a specific amount of content access latency. In particular, the exemplary GUI 200a includes a feature 202a (which is a box) for entering (e.g., inputting) a user elected fee amount (e.g., for electing a user elected fee amount from a plurality of undefined fee amounts). The exemplary GUI 200a (herein simply “GUI 200a”) further including text 212a that identifies the content 20 being bid on, text 203a that identifies the amount of content access latency being bid on, feature 208a for accessing (e.g., acquiring and/or presenting) contextual information 24 (e.g., historical information related to share prices of ACME), feature 210a for accessing previous consumer information 22, and feature 206a for submitting (e.g., transmitting) elections (e.g., user elected fee amount) of a user 12. Note that features 206a, 208a, and/or 210a may be elected by “clicking” such features. Note further that the content access latency (as indicated by text 203a) that may be bid on through GUI 200a is not modifiable by the user 12.

Referring now to FIG. 2B, which shows another GUI 200b that may be presented by the computing device 10* of FIG. 1 for soliciting/eliciting at least one bid 40 from a user 12 for accessing a particular content 20 with a specific amount of content access latency. As illustrated, the GUI 200b includes a feature 202b (which is a box) for entering (e.g., inputting) a user elected fee amount (e.g., for electing a user elected fee amount from a plurality of undefined fee amounts) similar to the feature 202a of FIG. 2A. However, unlike the GUI 200a of FIG. 2A, in this case, the GUI 200b includes a feature 204b (another box) that allows a user 12 to enter a user elected content access latency (e.g., for entering a user elected content access latency from a plurality of undefined content access latencies). GUI 200b, as further illustrated, includes text 212b that identifies the content 20 that is being bid on, text 209b that indicates contextual information 24 (e.g., historical market information) related to the content 20, and text 211b that indicates previous consumer information 22 (e.g., number and identity of other users 50 who have previous viewed the content 20 that is being bid on through the GUI 200b).

Turning now to FIG. 2C, which shows yet another GUI 200c for accessing a particular content 20 with a specific amount of content access latency. As illustrated, GUI 200c includes text 212c that identifies the content 20 that is being bid on, text 203c that indicates the non-modifiable content access latency that is also being bid on, and feature 202c for selecting a user elected fee amount from a plurality of predefined/indicated fee amounts. In particular, feature 202c includes a vertical scroll bar 205c that allows a user 12 to scroll through a plurality of predefined and indicated fee amounts in order to select a specific fee amount as the user elected fee amount.

FIG. 2D shows a GUI 200d that allows a user 12 to select a user elected fee amount from a plurality of predefined/indicated fee amounts similar to the GUI 200c of FIG. 2C as well as to select a user elected amount of content access latency from a plurality of predefined/indicated amounts of content access latencies. In particular, GUI 200d includes feature 202d for selecting the user elected fee amount from the plurality of predefined/indicated fee amounts and feature 204d for selecting a user elected amount of content access latency from the plurality of predefined/indicated amounts of content access latencies.

FIG. 2E illustrates a GUI 200e for entering multiple user elected fee amounts and for entering multiple user elected content access latencies for multiple preferences. In particular, GUI 200e include a feature 221e for entering a first user elected fee amount and a feature 231e for entering a first user elected content access latency for a first preference, a feature 222e for entering a second user elected fee amount and a feature 232e for entering a second user elected content access latency for a second preference, and a feature 223e for entering a third user elected fee amount and a feature 233e for entering a third user elected content access latency for a third preference. Note that the first preference being a preferred option over the second preference, and the second preference being a preferred option over the third preference.

FIG. 2F illustrates a GUI 200f for entering multiple user elected fee amounts for multiple predefined (non-modifiable) content access latencies for multiple preferences. In particular, GUI 200f includes a feature 221f for entering a first user elected fee amount for a first preference and text 241f that indicates a predefined first content access latency associated with the first preference, a feature 222f for entering a second user elected fee amount for a second preference and text 242f that indicates a predefined second content access latency associated with the second preference, and a feature 223f for entering a third user elected fee amount for a third preference and text 243f that indicates a predefined content access latency associated with the third preference.

FIGS. 2G, 2H, 2I, 2K, and 2M illustrate various GUIs for eliciting/soliciting bids 40 for accessing various types of content 20. For example, FIG. 2G illustrates a GUI 200g for soliciting/submitting one or more bids 40 for accessing a particular type of consumable media (e.g., digital novel/book with the title “The Godmother” as indicated by text 212g). Note that GUI 200g includes feature 213g for acquiring/presenting contextual data 24 in the form of an excerpt from the content 20 (e.g., digital novel). In contrast, FIG. 2H illustrates a GUI 200h for soliciting/submitting one or more bids 40 for accessing a particular type of news content (e.g., human interest news in the form of celebrity news as indicated by text 212h). FIG. 2I illustrates a GUI 200i for soliciting/submitting one or more bids 40 for accessing governmental/regulatory news (e.g., interest rate news as indicated by text 212i). FIG. 2K illustrates a GUI 200k for soliciting/submitting one or more bids 40 for accessing agricultural news (e.g., a summer crop report as indicated by text 212k). Finally, FIG. 2M illustrates a GUI 200m for soliciting/submitting one or more bids 40 for accessing a particular type of consumable media (e.g. a feature length movie titled “Star Battle” as indicated by text 212m). A more detailed discussion related to the exemplary GUIs illustrated in FIGS. 2A, 2B, 2C, 2D, 2E, 2F, 2G, 2H, 2I, 2K, and 2M will be provided below with respect to the various processes and operations to be described herein.

Referring now to FIGS. 3A and 3B, illustrating two block diagrams representing two different implementations of the computing device 10* of FIG. 1. In particular, and as will be further described herein, FIG. 3A illustrates a computing device 10′ that is the “hardwired” or “hard” implementation of a system that can implement the operations and processes to be described herein. The computing device 10′ may include certain logic modules including, for example, a bidding tag receiving module 101′, an interface providing module 102′, a bid obtaining module 103′, a bid transmitting module 104′, a content access obtaining module 106′, and/or a content access providing module 108′ that are implemented using purely hardware or circuitry components (e.g., application specific integrated circuit or “ASIC”). In contrast, FIG. 3B illustrates a computing device 10″ that is the “soft” implementation of a system that can implement the operations and processes to be described herein. In various embodiments, the computing device 10″ may include certain logic modules including, for example, a bidding tag receiving module 101″, an interface providing module 102″, a bid obtaining module 103″, a bid transmitting module 104″, a content access obtaining module 106″, and/or a content access providing module 108″ that are implemented using electronic circuitry (e.g., one or more processors including one or more microprocessors, controllers, etc.) executing one or more programming instructions (e.g., software in the form of computer readable instructions 152—see FIG. 3B).

The embodiments of the computing device 10* illustrated in FIGS. 3A and 3B are two extreme implementations of a system in which all of the logic modules (e.g., the bidding tag receiving module 101′, the interface providing module 102′, the bid obtaining module 103′, the bid transmitting module 104′, the content access obtaining module 106′, and the content access providing module 108′) are implemented using purely hardware solutions (e.g., circuitry such as ASIC) as illustrated in FIG. 3A or in which all of the logic modules (e.g., the bidding tag receiving module 101″, the interface providing module 102″, the bid obtaining module 103″, the bid transmitting module 104″, the content access obtaining module 106″, and the content access providing module 108″) are implemented using software solutions (e.g., programmable instructions in the form of computer readable instructions 152 being executed by hardware such as one or more processors) as illustrated in FIG. 3B. Since there are many ways of combining hardware, software, and/or firmware in order to implement the various logic modules (e.g., the bidding tag receiving module 101*, the interface providing module 102*, the bid obtaining module 103*, the bid transmitting module 104*, the content access obtaining module 106*, and the content access providing module 108*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 116 are still needed in order to execute the software. Further details related to the two implementations of the computing device 10* illustrated in FIGS. 3A and 3B will be provided in greater detail below.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring particularly now to FIG. 3A, which illustrates a block diagram of an computing device 10′ that includes a bidding tag receiving module 101′, an interface providing module 102′, a bid obtaining module 103′, a bid transmitting module 104′, a content access obtaining module 106′, a content access providing module 108′, one or more processors 116 (e.g., one or more microprocessors), a memory 114, a user interface 110 (e.g., a keyboard, a touchscreen, a liquid crystal display or LCD, a microphone, one or more speakers, and/or other types of user input/output devices), and/or a network interface 112 (e.g., a network interface card or “NIC”). In various embodiments, the memory 114 may store one or more applications 160 (e.g., an operating system (OS) 162, one or more browser applications 163, and/or one or more media player applications 164) and content 20. Although not depicted, the memory 114 may further include other types of applications not depicted in FIG. 3A including, for example, communication applications such as an email application and/or an instant messaging (IM) application. As briefly described above, the user interface 110 may comprise of one or more input/output (I/O) devices such as one or more displays, keyboard or keypad, microphones, speakers, mouse, and so forth, for interfacing with a user 12.

In various embodiments, the bidding tag receiving module 101′ of FIG. 3A is a logic module that may be designed to, among other things, receive a bidding tag 30 that may be designed to, when received by the computing device 10′, prompt the computing device 10′ to present an audio and/or visual interface (e.g., a GUI 200a, 200b, 200c, or 200d of FIG. 2A, 2B, 2C, or 2D) for soliciting from a user 12 at least one bid 40 for accessing a particular content 20 (with a particular amount of content access latency). In contrast, the interface providing module 102′ of FIG. 3A is a logic module that may be designed to, among other things, provide (e.g. display) an interface for eliciting at least one bid 40 from a user 12 for accessing a content 20 with a specific amount of content access latency, the at least one bid 40 to be elicited being defined by at least one user elected fee amount elected from a plurality of fee amounts available for election for the specific amount of content access latency, the user elected fee amount being an amount of fee being offered through the bid 40 in exchange for accessing the content following lapse of the specific amount of content access latency. The bid obtaining module 103′ of FIG. 3A, on the other hand, is a logic module that may be designed to, among other things, obtain the bid 40 from the user 12 as a result, at least in part, of the providing of the interface.

The bid transmitting module 104′ of FIG. 3A is a logic module that may be configured to transmit the bid 40 in response, at least in part, to obtaining the bid 40, the bid 40 to be transmitted defining at least the user elected fee amount. In contrast, the content access obtaining module 106′ of FIG. 3A is a logic module that may be configured to obtain at least access to the content 20 as a result, at least in part, of the transmitting of the bid 30. Finally, the content access providing module 108′ of FIG. 3A is a logic module that may be configured to provide at least the access to the content 20 following lapse of the specific amount of content access latency.

Turning now to FIG. 3B, which illustrates a block diagram of another computing device 10″ that can implement the operations and processes to be described herein. As indicated earlier, the computing device 10″ in FIG. 3B is merely the “soft” version of the computing device 10′ of FIG. 3A because the various logic modules: the bidding tag receiving module 101″, the interface providing module 102″, the bid obtaining module 103″, the bid transmitting module 104″, the content access obtaining module 106″, and the content access providing module 108″ are implemented using software and one or more processors 116 (e.g., one or more microprocessors or controllers) executing the software (e.g., computer readable instructions 152) rather than being implemented using purely hardware (e.g., ASIC) as was the case in the computing device 10′ of FIG. 3A. Thus, the bidding tag receiving module 101″, the interface providing module 102″, the bid obtaining module 103″, the bid transmitting module 104″, the content access obtaining module 106″, and the content access providing module 108″ of FIG. 3B may be designed to execute the same functions as the bidding tag receiving module 101′, the interface providing module 102′, the bid obtaining module 103′, the bid transmitting module 104′, the content access obtaining module 106′, and the content access providing module 108′, respectively, of FIG. 3A. The computing device 10″, as illustrated in FIG. 3B, has other components (e.g., user interface 110, network interface 112, and so forth) that are the same or similar to the other components included in the computing device 10′ of FIG. 3A. Note that in the embodiment of the computing device 10″ illustrated in FIG. 3B, the various logic modules (e.g., the bidding tag receiving module 101″, the interface providing module 102″, the bid obtaining module 103″, the bid transmitting module 104″, the content access obtaining module 106″, and the content access providing module 108″) may be implemented by the one or more processors 116 (or other types of circuitry such as field programmable gate arrays or FPGAs) executing one or more computer readable instructions 152 stored in memory 114.

In various embodiments, the memory 114 of the computing device 10′ of FIG. 3A and the computing device 10″ of FIG. 3B may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

Turning now to FIG. 4A illustrating a particular implementation of the interface providing module 102* (e.g., the interface providing module 102′ or the interface providing module 102″) of FIGS. 3A and 3B. As illustrated, the interface providing module 102* may further include at least one sub-logic module in various alternative embodiments. For example, in various embodiments, the interface providing module 102* may include a GUI providing module 402. Specific details related to the interface providing module 102* as well as the above-described sub-module of the interface providing module 102* will be provided below with respect to the operations and processes to be described herein.

FIG. 4B illustrates a particular implementation of the content access obtaining module 106* (e.g., the content access obtaining module 106′ or the content access obtaining module 106″) of FIG. 3A or 3B. As illustrated, the content access obtaining module 106* in various alternative embodiments may include one or more sub-logic modules including a link obtaining module 406, a content obtaining module 408, an access releasing instruction obtaining module 410, a contextual information access obtaining module 412, and/or a previous consumer information access obtaining module 414. Specific details related to the content access obtaining module 106*, as well as the above-described sub-modules of the content access obtaining module 106*, will be provided below with respect to the operations and processes to be described herein.

FIG. 4C illustrates a particular implementation of the content access providing module 108* (e.g., the content access providing module 108′ or the content access providing module 108″) of FIG. 3A or 3B. As illustrated, the content access providing module 108* may include one or more sub-logic modules in various alternative embodiments. For example, in various embodiments, the content access providing module 108* may include a content providing module 416, a news content access providing module 418, a consumable media access providing module 420, a contextual information access providing module 422, and/or a previous consumer information access providing module 424. Specific details related to the content access providing module 108*, as well as the above-described sub-modules of the content access providing module 108*, will be provided below with respect to the operations and processes to be described herein.

A more detailed discussion related to the computing device 10* (e.g., the computing device 10′ of FIG. 3A or the computing device 10″ of FIG. 3B) discussed above will now be provided with respect to the processes and operations to be described herein. FIG. 5 illustrates an operational flow 500 representing example operations for, among other things, providing a particular level of access to content from a plurality of graduated levels of access to the content. In various implementations, these operations may be implemented by the computing device 10* of FIG. 3A or 3B.

In FIG. 5 and in the following figures that include various examples of operational flows, discussions and explanations will be provided with respect to the computing device 10* described above and as illustrated in FIGS. 3A, 3B, 4A, 4B, 4C, and/or with respect to other examples (e.g., as provided in FIGS. 1, 2A, 2B, 2C, 2D, 2E, 2F, 2G, 2H, 2I, 2K, and 2M) and contexts. However, it should be understood that the operational flows may be executed in a number of other environments and contexts, and/or in modified versions of FIGS. 1, 2A, 2B, 2C, 2D, 2E, 2F, 2G, 2H, 2I, 2K, 2M, 3A, 3B, 4A, 4B, and/or 4C. Also, although the various operational flows are presented in the sequence(s) illustrated, it should be understood that the various operations may be performed in other orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

In any event, after a start operation, the operational flow 500 of FIG. 5 may move to an interface presenting operation 502 for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency. For instance, and as illustration, the interface providing module 102* of the computing device 10* of FIG. 3A or 3B (e.g., the interface providing module 102′ of FIG. 3A or the interface providing module 102″ of FIG. 3B) presenting (e.g., providing) an interface for soliciting (e.g., requesting) at least one bid 40 from a user 12 (e.g., a person, a group of persons, a private or public organization, etc.) for accessing a content 20 following lapse of a specific amount of content access latency (e.g., time delay), the at least one bid 40 to be solicited including at least one user elected fee amount elected from a plurality of (varying or tiered levels of) fee amounts available (e.g., available through the interface) for election by the user 12 for the specific amount of content access latency, the user elected fee amount being an amount of fee being offered through the bid 40 in exchange for accessing the content 20 following lapse of the specific amount of content access latency.

Operational flow 500 may also include a bid relaying operation 504 for relaying the bid in response, at least in part, to obtaining the bid as a result of the soliciting, the bid to be relayed indicating at least the user elected fee amount. For instance, the bid transmitting module 104* (e.g., the bid transmitting module 104′ of FIG. 3A or the bid transmitting module 104″ of FIG. 3B) of the computing device 10* of FIG. 3A or 3B relaying (e.g., transmitting) the bid 40 in response, at least in part, to obtaining the bid 40 as a result of the soliciting, the bid 40 to be relayed (e.g., transmitted) indicating at least the user elected fee amount (e.g., the amount of fee a user 12 is offering to pay in exchange for access to the content 20 following lapse of an agreed upon content access latency).

As further illustrated in FIG. 5, operational flow 500 may also include a content access acquiring operation 506 for acquiring at least access to the content as a result, at least in part, of the relaying. For instance, the content access obtaining module 106* (e.g., content access obtaining module 106′ of FIG. 3A or the content access obtaining module 106″ of FIG. 3B) of the computing device 10* of FIG. 3A or 3B acquiring (e.g., obtaining) at least access to the content 20 as a result, at least in part, of the relaying of the bid 40.

As also illustrated in FIG. 5, operational flow 500 may further include a content access presenting operation 508 for presenting at least the access to the content following lapse of the specific amount of content access latency. For instance, the content access providing module 108* (e.g., the content access providing module 108′ of FIG. 3A or the content access providing module 108″ of FIG. 3B) of the computing device 10* of FIG. 3A or 3B presenting (e.g., providing) at least the access to the content 20 following lapse of the specific amount of content access latency (e.g., the specific time delay for accessing the content 20 as agreed to through, for example, the bid 40).

As will be described below, the interface presenting operation 502, the bid relaying operation 504, the content access acquiring operation 506, and the content access presenting operation 508 may be executed in a variety of different ways in various alternative implementations. FIGS. 6A, 6B, 6C, 6D, 6E, 6F, and 6G, for example, illustrate at least some of the alternative ways that the interface presenting operation 502 of FIG. 5 may be executed in various alternative implementations. In some cases, for example, the interface presenting operation 502 may include an operation 602 for presenting the interface for soliciting the bid by presenting an audio interface that is an audio channel for audibly soliciting the bid as illustrated in FIG. 6A. For instance, the interface providing module 102* of the computing device 10* (e.g., the computing device 10′ of FIG. 3A or the computing device 10″ of FIG. 3B) presenting the interface for soliciting the bid 40 by presenting (providing) an audio interface (e.g., an audio interface as provided through one or more audio I/O devices such as one or more speakers and/or microphones) that is an audio channel for audibly soliciting the bid 40. For example, employing one or more speakers to solicit or elicit a user 12 to submit a bid 40 by audibly requesting the user 12 to submit at least a user elected fee amount (e.g., an amount of fee that the user 12 is offering) for accessing the content 20 following lapse of the specific amount of content access latency. One or more microphones may then be used in order to receive the requested or solicited bid 40 from the user 12.

As further illustrated in FIG. 6A, in some implementations, the interface presenting operation 502 may alternatively or additionally include or involve an operation 603 for presenting the interface for soliciting the bid by presenting a visual interface that is a visual channel for visually soliciting the bid. For instance, the interface providing module 102* of the computing device 10* of FIG. 3A or 3B presenting the interface for soliciting the bid 40 by presenting (e.g., providing) a visual interface (e.g., a visual interface as provided through one or more visual I/O devices such as one or more touchscreen or other types of displays in combination with, for example, a mouse, a keyboard, a keypad, etc.) that is a visual channel for visually soliciting the bid 40. For example, employing a touchscreen or other types of displays to solicit (e.g., elicit or request) that a user 12 submit a bid 40 by visually eliciting the user 12 to submit at least a user elected fee amount that the user 12 is offering to pay in exchange for being allowed to access the content 20 after lapse of a specific amount of content access latency agreed to through the bid 40. The touchscreen, a keypad or keyboard, or a mouse may then be used in order to receive the requested bid 40 from the user 12.

In some implementations, the interface presenting operation 502 may actually include or involve an operation 604 for presenting the interface for soliciting the bid by presenting a visual/audio interface that is a visual and audio channel for visually and audibly soliciting the bid. For instance, the interface providing module 102* of the computing device 10* of FIG. 3A or 3B presenting the interface for soliciting the bid 40 by presenting a visual/audio interface that is a visual and audio channel for visually and audibly soliciting the bid 40. For example, providing a channel through one or more display devices and one or more speakers for visually and audibly soliciting or requesting the bid 40.

In the same or alternative implementations, the interface presenting operation 502 may additionally or alternatively include an operation 605 for presenting the interface for soliciting the bid by presenting the interface via one or more input/output (I/O) devices. For instance, the interface providing module 102* of the computing device 10* of FIG. 3A or 3B presenting the interface for soliciting the bid 40 by presenting the interface via one or more input/output (I/O) devices (e.g., a liquid crystal display or LCD, a touchscreen, a speaker, a microphone, a keypad, a mouse, and so forth).

In the same or alternative implementations, the interface presenting operation 502 may additionally or alternatively include an operation 606 for presenting the interface for soliciting the bid by presenting an interface that is a channel for requesting submission of the bid, the requested bid to include at least the at least one user elected fee amount. For instance, the interface providing module 102* of the computing device 10* of FIG. 3A or 3B presenting the interface for soliciting the bid 40 by presenting an interface that is a channel for requesting submission of the bid 40, the requested bid 40 to include at least the at least one user elected fee amount.

In some implementations, operation 606 may actually involve an operation 607 for presenting the interface that is the channel for requesting submission of the bid by presenting an interface that is a channel for requesting submission of the bid and for receiving the bid. For instance, the interface providing module 102* of the computing device 10* of FIG. 3A or 3B presenting the interface that is the channel for requesting submission of the bid 40 by presenting an interface that is a channel for requesting submission of the bid 40 and for receiving the bid 40. For example, employing a touchscreen or a combination of a LCD display and a mouse and/or keyboard for eliciting the bid 40 as well as for obtaining the bid 40.

In some cases, the interface that is presented for soliciting the bid 40 may be in the form of a visual GUI. For example, in various implementations the interface presenting operation 502 of FIG. 5 may actually include or involve an operation 608 for presenting an interface for soliciting the bid by presenting a graphical user interface (GUI) for submitting one or more bids as illustrated in FIG. 6B. For instance, the interface providing module 102* including the GUI providing module 402 (see FIG. 4A) of the computing device 10* of FIG. 3A or 3B presenting an interface for soliciting the bid 40 by presenting (e.g., providing) a GUI (see, for example, GUI 200a, 200b, 200c, 200d, 200e, or 200f of FIG. 2A, 2B, 2C, 2D, 2E, or 2F) for submitting one or more bids 40. Note that the operation 608 for presenting a visual GUI (as well as the operations related to operation 608 to be described herein) can also be audibly presented in various alternative implementations. That is, an audio version of the GUI that is described herein for eliciting/submitting one or more bids 40 can alternatively be audibly presented as those of ordinary skill in the art will recognize. To illustrate, the audio version of the GUI would audibly request that the user 12 submit a bid 40 orally or by other means (e.g., by keypad or touchscreen).

As further illustrated in FIGS. 6B, 6C, 6D, 6E, 6F and 6G, operation 608 may actually include or involve one or more additional operations in various alternative implementations. For example, in some implementations, operation 608 may involve an operation 609 for presenting the GUI for submitting the one or more bids by presenting a GUI that includes at least one feature for electing the user elected fee amount. For instance, the GUI providing module 402 of the computing device 10* of FIG. 3A or 3B presenting the GUI for submitting the one or more bids 40 by presenting a GUI that includes at least one feature (e.g., feature 202a, 202b, 202c, and 202d of FIGS. 2A, 2B, 2C, and 2D) that may be used by, for example, a user 12 in order to elect the user elected fee amount.

In some cases, operation 609 may further include an operation 610 for presenting the GUI that includes at least the one feature for electing the user elected fee amount by presenting a GUI that includes at least one feature for entering the user elected fee amount. For instance, the GUI providing module 402 of the computing device 10* of FIG. 3A or 3B presenting the GUI that includes at least the one feature for electing the user elected fee amount by presenting a GUI 200a or 200b (see FIG. 2A or 2B) that includes at least one feature 202a or 202b (see FIG. 2A or 2B) for entering the user elected fee amount.

In some cases, operation 609 may additionally or alternatively include an operation 611 for presenting the GUI that includes at least the one feature for electing the user elected fee amount by presenting a GUI that includes at least one feature for selecting the user elected fee amount from a plurality of varying fee amounts that are selectable through the at least one feature. For instance, the GUI providing module 402 of the computing device 10* of FIG. 3A or 3B presenting the GUI that includes at least the one feature for electing the user elected fee amount by presenting a GUI 200c or 200d (see FIG. 2C or 2D) that includes at least one feature 202c or 202d (see FIG. 2C or 2D) for selecting the user elected fee amount from a plurality of varying fee amounts that are selectable (e.g., predefined fee amounts that can be selected) through the at least one feature 202c or 202d.

As further illustrated in FIG. 6B, operation 611 may, in some implementation, actually include or involve an operation 612 for presenting the GUI that includes the at least one feature for selecting the user elected fee amount from the plurality of varying fee amounts that are selectable through the at least one feature by presenting a GUI that includes at least one feature for selecting the user elected fee amount from a plurality of varying fee amounts that are identified by the GUI. For instance, the GUI providing module 402 of the computing device 10* of FIG. 3A or 3B presenting the GUI 200c or 200d (see FIG. 2C or 2B) that includes the at least one feature 202c or 202d for selecting the user elected fee amount from the plurality of varying fee amounts that are selectable through the at least one feature 202c or 202d by presenting a GUI 200c or 200d that includes at least one feature 202c or 202d for selecting the user elected fee amount from a plurality of varying (e.g., tiered levels) fee amounts that are identified (e.g., indicated) by the GUI 200c or 200d.

In some implementations, operation 608 may include or involve an operation 613 for presenting the GUI for submitting the one or more bids by presenting a GUI that includes at least one feature for submitting a bid for accessing the content following lapse of a predefined amount of content access latency that is not modifiable by a user. For instance, the GUI providing module 402 of the computing device 10* of FIG. 3A or 3B presenting the GUI for submitting the one or more bids 40 by presenting a GUI 200a or 200c (see FIG. 2A or 2C) that includes at least one feature 202a or 202c for submitting a bid 40 for accessing the content 20 following lapse of a predefined amount of content access latency (e.g., as indicated by text 203a or 203c of FIG. 2A or 2C) that is not modifiable by a user. Note that in the cases of GUIs 200a and 200c of FIGS. 2A and 2C, a user 12 will not be able to modify the content access latencies (as indicated by text 203a and 203c) that are being bid on since the content access latencies are preset.

Turning now to FIG. 6C, in various implementations, operation 608 may include or involve an operation 614 for presenting the GUI for submitting the one or more bids by presenting a GUI that includes at least one feature for electing the specific amount of content access latency. For instance, the GUI providing module 402 of the computing device 10* of FIG. 3A or 3B presenting the GUI for submitting the one or more bids 40 by presenting a GUI 200b or 200d (see FIG. 2B or 2D) that includes at least one feature 204b or 204d for electing the specific amount of content access latency (e.g., a user 12 being allowed to choose the amount of content access latency to be bid on through, for example, the feature 204b or 204d).

In some cases, operation 614 may actually involve an operation 615 for presenting the GUI that includes at least the one feature for electing the specific amount of content access latency by presenting a GUI that includes at least one feature for selecting the specific amount of content access latency from a plurality of varying amounts of content access latencies. For instance, the GUI providing module 402 of the computing device 10* of FIG. 3A or 3B presenting the GUI that includes at least the one feature for electing the specific amount of content access latency by presenting a GUI 200d (see FIG. 2D) that includes at least one feature 204d for selecting the specific amount of content access latency from a plurality of varying (e.g., tiered levels) amounts of content access latencies.

In some implementations, operation 615 may actually include or involve an operation 616 for presenting the GUI that includes at least one feature for selecting the specific amount of content access latency from the plurality of varying amounts of content access latencies by presenting a GUI that includes at least one feature for selecting the specific amount of content access latency from a plurality of varying amounts of content access latencies that are identified by the at least one feature. For instance, the GUI providing module 402 of the computing device 10* of FIG. 3A or 3B presenting the GUI 200d (see FIG. 2D) that includes at least one feature 204d for selecting the specific amount of content access latency from the plurality of varying amounts of content access latencies by presenting a GUI 200d that includes at least one feature 204d for selecting the specific amount of content access latency from a plurality of varying amounts (e.g., tiered levels) of content access latencies that are identified or indicated by the at least one feature 204d.

In some implementations, operation 614 may actually include or involve an operation 617 for presenting the GUI that includes at least the one feature for electing the specific amount of content access latency by presenting a GUI that includes at least one feature for entering the specific amount of content access latency. For instance, the GUI providing module 402 of the computing device 10* of FIG. 3A or 3B presenting the GUI that includes at least the one feature for electing the specific amount of content access latency by presenting a GUI 200b (see FIG. 2B) that includes at least one feature 204b for entering the specific amount of content access latency. For example, the GUI 200b of FIG. 2B may be used by a user 12 to enter a particular amount of content access latency that the user 12 will be bidding on.

In various implementations, operation 608 may actually include or involve an operation 618 for presenting the GUI for submitting the one or more bids by presenting a GUI that includes at least a first feature for electing the user elected fee amount and a second feature for electing the specific amount of content access latency. For instance, the GUI providing module 402 of the computing device 10* of FIG. 3A or 3B presenting the GUI for submitting the one or more bids 40 by presenting a GUI 200b or 200d (see FIG. 2B or 2D) that includes at least a first feature 202b or 202d for electing the user elected fee amount and a second feature 204b or 204d for electing the specific amount of content access latency.

In some implementations, operation 618 may further involve an operation 619 for presenting the GUI that includes at least the first feature for electing the user elected fee amount and the second feature for electing the specific amount of content access latency by presenting a GUI that includes at least a first feature for entering the user elected fee amount and a second feature for entering the particular amount of content access latency. For instance, the GUI providing module 402 of the computing device 10* of FIG. 3A or 3B presenting the GUI that includes at least the first feature for electing the user elected fee amount and the second feature for electing the specific amount of content access latency by presenting a GUI 200b (see FIG. 2B) that includes at least a first feature 202b for entering the user elected fee amount and a second feature 204b for entering the particular amount of content access latency.

In some implementations, operation 618 may alternatively or additionally involve an operation 620 for presenting the GUI that includes at least the first feature for electing the user elected fee amount and the second feature for electing the specific amount of content access latency by presenting a GUI that includes at least a first feature for selecting the user elected fee amount from a plurality of varying fee amounts that are selectable through the first feature and a second feature for selecting the specific amount of content access latency from a plurality of varying amounts of content access latencies. For instance, the GUI providing module 402 of the computing device 10* of FIG. 3A or 3B presenting the GUI that includes at least the first feature for electing the user elected fee amount and the second feature for electing the specific amount of content access latency by presenting a GUI 200d (see FIG. 2D) that includes at least a first feature 202d for selecting the user elected fee amount from a plurality of varying fee amounts that are selectable (e.g., predefined fee amounts that can be selected) through the first feature 202d and a second feature for selecting the specific amount of content access latency from a plurality of varying amounts (e.g., tiered levels) of content access latencies.

Referring now to FIG. 6D, in various implementations, operation 608 may include an operation 621 for presenting the GUI for submitting the one or more bids by presenting a GUI that at least partially identifies the content. For instance, the GUI providing module 402 of the computing device 10* of FIG. 3A or 3B presenting the GUI for submitting the one or more bids 40 by presenting a GUI 200a, 200b, 200c, 200d, 200e, 200f, or 200g (see FIG. 2A, 2B, 2C, 2D, 2E, 2F, or 2G) that at least partially identifies the content 20 (see text 212a, 212b, 212c, 212d, 212e, 212f, or 212g, which identifies content 20).

As further illustrated in FIG. 6D, operation 621 may further include or involve one or more additional operations including, in some cases, an operation 622 for presenting the GUI that at least partially identifies the content by presenting a GUI that identifies the content as being at least a particular type of news. For instance, the GUI providing module 402 of the computing device 10* of FIG. 3A or 3B presenting or providing the GUI that at least partially identifies the content 20 by presenting a GUI (see, for example, GUI 200a, 200b, 200c, 20d, 200e, 200f, 200h, 200i, or 200k of FIG. 2A, 2B, 2C, 2D, 2E, 2F, 2H, 2I, or 2K) that identifies (see text 212a, 212b, 212c, 212d, 212e, 212f, 212h, 212i, or 212k of FIG. 2A, 2B, 2C, 2D, 2E, 2F, 2H, 2I, or 2K) the content 20 as being at least a particular type of news (e.g., financial or market news, regulatory news, commodity pricing, interest rates, crop reports, and so forth).

As further illustrated in FIG. 6D, operation 622 in various implementations may further include or involve an operation 623 for presenting the GUI that identifies the content as being at least a particular type of news by presenting a GUI that identifies the content as being a particular type of business, financial, and/or market news. For instance, the GUI providing module 402 of the computing device 10* of FIG. 3A or 3B presenting the GUI that identifies the content 20 as being at least a particular type of news by presenting a GUI (e.g., GUI 200a, 200b, 200c, 200d, 200e, 200f, or 200i of FIG. 2A, 2B, 2C, 2D, 2E, 2F, or 2I) that identifies (see, for example, text 212a, 212b, 212c, 212d, 212e, 212f, or 212i of FIG. 2A, 2B, 2C, 2D, 2E, 2F, or 2I) the content 20 as being a particular type of business, financial, and/or market news.

In some implementations, operation 622 may include or involve an operation 624 for presenting the GUI that identifies the content as being at least a particular type of news by presenting a GUI that identifies the content as being human interest news. For instance, the GUI providing module 402 of the computing device 10* of FIG. 3A or 3B presenting the GUI that identifies the content 20 as being at least a particular type of news by presenting a GUI (e.g., GUI 200h) that identifies (see, for example, text 212h) the content 20 as being human interest news (e.g., news related to a particular person or persons such as celebrities, news related to a natural disaster, news related to societal events, or other types of news that may be of general interest to the public at large).

In some implementations, operation 624 may actually involve or include an operation 625 for presenting the GUI that identifies the content as being human interest news by presenting a GUI that identifies the content as being a particular type of celebrity news. For instance, the GUI providing module 402 of the computing device 10* of FIG. 3A or 3B presenting the GUI that identifies the content 20 as being human interest news by presenting a GUI (e.g., GUI 200h of FIG. 2H) that identifies (e.g., as indicated by text 212h of FIG. 2H) the content 20 as being a particular type of celebrity news (e.g., news related to a particular celebrity).

In some implementations, operation 622 may include an operation 626 for presenting the GUI that identifies the content as being at least a particular type of news by presenting a GUI that identifies the content as being political, governmental, or regulatory news. For instance, the GUI providing module 402 of the computing device 10* of FIG. 3A or 3B presenting the GUI that identifies the content 20 as being at least a particular type of news by presenting a GUI (e.g., GUI 200i or 200k of FIG. 2I or 2K) that identifies (e.g., text 212i or 212k of FIG. 2I or 2K) the content 20 as being political, governmental, or regulatory news.

In some implementations, operation 621 for presenting the GUI for submitting the one or more bids by presenting a GUI that at least partially identifies the content may include or involve an operation 627 for presenting the GUI that at least partially identifies the content by presenting a GUI that identifies the content as being a particular consumable media. For instance, the GUI providing module 402 of the computing device 10* of FIG. 3A or 3B presenting the GUI that at least partially identifies the content 20 by presenting a GUI (e.g., GUI 200g or GUI 200m of FIG. 2G or 2M) that identifies (see, for example, text 212g or 212m of FIG. 2G or 2M) the content 20 as being a particular consumable media (e.g., a movie, a novel, a reference book, an audio recording, and so forth).

In some cases, operation 627 may actually include or involve an operation 628 for presenting the GUI that identifies the content as being a particular consumable media by presenting a GUI that identifies the content as being a particular movie, a particular video recording, a particular audio recording, or a textual document. For instance, the GUI providing module 402 of the computing device 10* of FIG. 3A or 3B presenting the GUI that identifies the content 20 as being the particular consumable media by presenting a GUI (e.g., GUI 200g or 200m of FIG. 2G or 2M) that identifies (see, for example, text 212g or 212m of FIG. 2G or 2M) the content 20 as being a particular movie, a particular video recording (e.g., a recording of a sporting event), a particular audio recording (e.g., a cd recording or soundtrack), or a textual document (e.g., a novel or a reference book).

Turning now to FIG. 6E, in various implementations, operation 608 for presenting an interface for soliciting the bid by presenting a graphical user interface (GUI) for submitting one or more bids may actually include or involve an operation 629 for presenting the GUI for submitting the one or more bids by presenting a GUI for submitting at least one bid and that provides access to contextual information related to the content. For instance, the GUI providing module 402 of the computing device 10* of FIG. 3A or 3B presenting the GUI for submitting the one or more bids 40 by presenting a GUI (e.g., GUI 200a, 200b, or 200m of FIG. 2A, 2B, or 2M) for submitting at least one bid 40 (e.g., a user elected fee for a user elected content access latency) and that provides access to contextual information 24 (e.g., historical background information or movie trailers) related to the content 20. For example, in FIG. 2A, a feature 208a is provided that may be selected by a user 12 in order to access contextual information in the form of historical information related to the content 20 (e.g., stock market information). FIG. 2B shows a GUI 200b that includes text 209b that shows contextual information (e.g., historical market data) related to the content 20 (e.g., price of a particular stock on a particular day). FIG. 2M, on the other hand, shows a feature 208m that is provided that may be selected by a user 12 in order to access one or more movie trailers associated with the content 20 (e.g., a movie).

As further illustrated in FIG. 6E, in various implementations, operation 629 may include one or more additional operations including, in some cases, an operation 630 for presenting the GUI for submitting the at least one bid and that provides access to contextual information related to the content by presenting a GUI for submitting the at least one bid and that provides an option for retrieving and/or presenting the contextual information. For instance, the GUI providing module 402 of the computing device 10* of FIG. 3A or 3B presenting the GUI for submitting the at least one bid 40 and that provides access to contextual information 24 related to the content 20 by presenting a GUI (e.g., GUI 200a of FIG. 2A) for submitting the at least one bid 40 and that provides an option (e.g., feature 208a) for retrieving and/or presenting the contextual information 24 (e.g., historical market information).

In some implementations, operation 629 may include an operation 631 for presenting the GUI for submitting the at least one bid and that provides access to contextual information related to the content by presenting a GUI for submitting the at least one bid and that shows the contextual information. For instance, the GUI providing module 402 of the computing device 10* of FIG. 3A or 3B presenting the GUI for submitting the at least one bid 40 and that provides access to contextual information 24 related to the content 20 by presenting a GUI (e.g., GUI 200b of FIG. 2B) for submitting the at least one bid 40 (e.g., at least a user elected fee amount and, in some cases, a user elected content access latency) and that shows the contextual information 24 (e.g., text 209b of FIG. 2B, which shows historical information related to the content 20 in the form of a previous high market price).

In some implementations, operation 629 may include an operation 632 for presenting the GUI for submitting the at least one bid and that provides access to contextual information related to the content by presenting a GUI for submitting the at least one bid and that provides access to historical background information related to the content. For instance, the GUI providing module 402 of the computing device 10* of FIG. 3A or 3B presenting the GUI for submitting the at least one bid 40 and that provides access to contextual information 24 related to the content 20 by presenting a GUI (e.g., GUI 200a or 200b) for submitting the at least one bid 40 (e.g., user elected fee amount) and that provides access (see feature 208a of FIG. 2A for retrieving/accessing contextual information or text 209b of FIG. 2B, which provides the contextual information) to historical background information related to the content 20.

In some implementations, operation 629 may include an operation 633 for presenting the GUI for submitting the at least one bid and that provides access to contextual information related to the content by presenting a GUI for submitting the at least one bid and that provides access to one or more movie trailers related to the content. For instance, the GUI providing module 402 of the computing device 10* of FIG. 3A or 3B presenting the GUI for submitting the at least one bid 40 and that provides access to contextual information 24 related to the content 20 by presenting a GUI (e.g., GUI 200m of FIG. 2M) for submitting the at least one bid 40 and that provides access (e.g., feature 208m, which may be selected or “clicked” by a user 12) to one or more movie trailers related to the content 20 (e.g., a movie). Note that the one or more movie trailers that access may be provided to may be the movie trailers for the particular movie included in the content 20, or for a movie related to (e.g., a sequel) or is in the same genre (e.g., romance, horror, etc.) as the movie included in the content 20.

In some implementations, 608 may additionally or alternatively include or involve an operation 634 for presenting the GUI for submitting the one or more bids by presenting a GUI for submitting at least one bid and that provides access to previous consumer information related to one or more users who have previously accessed the content as illustrated in FIG. 6F. For instance, the GUI providing module 402 of the computing device 10* of FIG. 3A or 3B presenting (e.g., providing) the GUI for submitting the one or more bids 40 by presenting a GUI (e.g., GUI 200a or GUI 200b of FIG. 2A or 2B) for submitting at least one bid 40 and that provides access (e.g., display the previous consumer information 22 as illustrated in FIG. 2B or providing an option (e.g., feature 210a) for displaying the previous consumer information 22 as illustrated in FIG. 2A) to previous consumer information 22 related to one or more other users 50 who have previously accessed the content 20.

As further illustrated in FIG. 6F, operation 634 may further include one or more additional operations in various alternative implementations including, in some cases, an operation 635 for presenting the GUI for submitting the at least one bid and that provides the access to the previous consumer information related to the one or more users who have previously accessed the content by presenting a GUI for submitting at least one bid and that provides an option for retrieving and/or presenting the previous consumer information. For instance, the GUI providing module 402 of the computing device 10* of FIG. 3A or 3B presenting the GUI for submitting the at least one bid 40 and that provides the access to the previous consumer information 22 related to the one or more users 50 who have previously accessed the content 20 by presenting a GUI (e.g., GUI 200a) for submitting at least one bid 40 (e.g., a user elected fee amount) and that provides an option (e.g., feature 210a of FIG. 2A, which may be selected or “clicked” by a user 12) for retrieving and/or presenting the previous consumer information 22.

In the same or alternative implementations, operation 634 may additionally or alternatively include an operation 636 for presenting the GUI for submitting the at least one bid and that provides the access to the previous consumer information related to the one or more users who have previously accessed the content by presenting a GUI for submitting the at least one bid and that displays the previous consumer information. For instance, the GUI providing module 402 of the computing device 10* of FIG. 3A or 3B presenting the GUI for submitting the at least one bid 40 and that provides the access to the previous consumer information 22 related to the one or more other users 50 who have previously accessed the content 20 by presenting a GUI (e.g., GUI 200b of FIG. 2B) for submitting the at least one bid 40 and that displays (see, for example, text 211b of FIG. 2B) the previous consumer information 22.

In the same or alternative implementations, operation 634 may additionally or alternatively include an operation 637 for presenting the GUI for submitting the at least one bid and that provides the access to the previous consumer information related to the one or more users who have previously accessed the content by presenting a GUI for submitting the at least one bid and that provides access to previous consumer information that identifies the one or more users who have previously accessed the content and/or the number of one or more users who have previously accessed the content. For instance, the GUI providing module 402 of the computing device 10* of FIG. 3A or 3B presenting the GUI for submitting the at least one bid 40 and that provides the access to the previous consumer information 22 related to the one or more other users 50 who have previously accessed the content 20 by presenting a GUI (e.g., GUI 200a or 200b of FIG. 2A or 2B) for submitting the at least one bid 40 and that provides access to previous consumer information 22 that identifies the one or more other users 50 who have previously accessed the content 20 and/or the number of one or more other users 50 who have previously accessed the content 20.

In the same or alternative implementations, operation 634 may additionally or alternatively include an operation 638 for presenting the GUI for submitting the at least one bid and that provides the access to the previous consumer information related to the one or more users who have previously accessed the content by presenting a GUI for submitting the at least one bid and that provides access to previous consumer information that indicates when and/or how the one or more users who have previously accessed the content actually accessed the content. For instance, the GUI providing module 402 of the computing device 10* of FIG. 3A or 3B presenting the GUI for submitting the at least one bid 40 and that provides the access to the previous consumer information 22 related to the one or more other users 50 who have previously accessed the content 20 by presenting a GUI (e.g., GUI 200a of FIG. 2A) for submitting the at least one bid 40 and that provides access to previous consumer information 22 that indicates when and/or how (e.g., bandwidth or type of network used) the one or more other users 50 who have previously accessed the content 20 actually accessed the content 20.

Referring now to FIG. 6G, in various implementations, operation 608 for presenting an interface for soliciting the bid by presenting a graphical user interface (GUI) for submitting one or more bids may additionally or alternatively include an operation 639 for presenting the GUI for submitting the one or more bids by presenting the GUI for submitting the one or more bids in response, at least in part, to receiving a bidding tag that is designed to at least facilitate generation of the GUI. For instance, the GUI providing module 402 of the computing device 10* of FIG. 3A or 3B presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 by presenting the GUI (e.g., GUI 200a, 200b, 200c, 200d, 200e, 200f, 200g, 200h, 200i, 200k or 200m) for submitting the one or more bids 40 in response, at least in part, to receiving by the bidding tag receiving module 101* of a bidding tag 30 that is designed to at least facilitate generation of the GUI (e.g., GUI 200a, 200b, 200c, 200d, 200e, 200f, 200g, 200h, 200i, 200k or 200m).

As further illustrated in FIG. 6G, operation 639, in various implementations, may include one or more additional operations including, in some cases, an operation 640 for presenting the GUI for submitting the one or more bids in response, at least in part, to receiving the bidding tag that is designed to at least facilitate the generation of the GUI by presenting the GUI for submitting the one or more bids in response, at least in part, to receiving the bidding tag via one or more wireless and/or wired networks 5. For instance, the GUI providing module 402 of the computing device 10* of FIG. 3A or 3B presenting the GUI for submitting the one or more bids 40 in response, at least in part, to receiving the bidding tag 30 that is designed to at least facilitate the generation of the GUI by presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 in response, at least in part, to receiving by the bidding tag receiving module 101* of the bidding tag 30 via one or more wireless and/or wired networks 5.

In the same or alternative implementations, operation 639 may additionally or alternatively include an operation 641 for presenting the GUI for submitting the one or more bids in response, at least in part, to receiving the bidding tag that is designed to at least facilitate the generation of the GUI by presenting the GUI for submitting the one or more bids in response, at least in part, to receiving a bidding tag that at least partially identifies the content. For instance, the GUI providing module 402 of the computing device 10* of FIG. 3A or 3B presenting the GUI for submitting the one or more bids 40 in response, at least in part, to receiving the bidding tag 30 that is designed to at least facilitate the generation of the GUI by presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 in response, at least in part, to receiving by the bidding tag receiving module 101* of a bidding tag 30 that at least partially identifies the content 20. For example, a bidding tag 30 that identifies the content 20 as a price of a particular stock on a particular date, that identifies the content 20 as interest rate news, that identifies the content 20 as crop reports or oil production reports, and so forth.

In the same or alternative implementations, operation 639 may additionally or alternatively include an operation 642 for presenting the GUI for submitting the one or more bids in response, at least in part, to receiving the bidding tag that is designed to facilitate at least the generation of the GUI by presenting the GUI for submitting the one or more bids in response, at least in part, to receiving a bidding tag that at least identifies a range of fee amounts available for selection. For instance, the GUI providing module 402 of the computing device 10* of FIG. 3A or 3B presenting the GUI for submitting the one or more bids 40 in response, at least in part, to receiving the bidding tag 30 that is designed to facilitate at least the generation of the GUI by presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 in response, at least in part, to receiving by the bidding tag receiving module 101* of a bidding tag 30 that at least identifies a range (e.g., different and tiered amounts) of fee amounts available for selection.

In the same or alternative implementations, operation 639 may additionally or alternatively include an operation 643 for presenting the GUI for submitting the one or more bids in response, at least in part, to receiving the bidding tag that is designed to at least facilitate the generation of the GUI by presenting the GUI for submitting the one or more bids in response, at least in part, to receiving a bidding tag that at least identifies a range of varying amounts of content access latencies available for selection by a user. For instance, the GUI providing module 402 of the computing device 10* of FIG. 3A or 3B presenting the GUI for submitting the one or more bids 40 in response, at least in part, to receiving the bidding tag 30 that is designed to at least facilitate the generation of the GUI by presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 in response, at least in part, to receiving by the bidding tag receiving module 101* of a bidding tag 30 that at least identifies a range of varying amounts of content access latencies available for selection by a user 12.

In the same or alternative implementations, operation 639 may additionally or alternatively include an operation 644 for presenting the GUI for submitting the one or more bids in response, at least in part, to receiving the bidding tag that is designed to at least facilitate the generation of the GUI by presenting the GUI for submitting the one or more bids in response, at least in part, to receiving a bidding tag that identifies a specific amount of content access latency that is not modifiable. For instance, the GUI providing module 402 of the computing device 10* of FIG. 3A or 3B presenting the GUI for submitting the one or more bids 40 in response, at least in part, to receiving the bidding tag 30 that is designed to at least facilitate the generation of the GUI by presenting the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) for submitting the one or more bids 40 in response, at least in part, to receiving by the bidding tag receiving module 101* of a bidding tag 30 that identifies a specific amount of content access latency that is not modifiable (e.g., a content access latency that can be bid on but cannot be modified by a user 12).

Referring back to the bid relaying operation 504 of FIG. 5, the bid relaying operation 504 similar to the interface presenting operation 502 of FIG. 5 may be executed in a number of different ways in various alternative embodiments as illustrated in FIGS. 7A, 7B, and 7C. In some implementations, for example, the bid relaying operation 504 may include an operation 745 for relaying the bid by relaying the bid via one or more wireless and/or wired networks as illustrated in FIG. 7A. For instance, the bid transmitting module 104* of the computing device 10* of FIG. 3A or 3B relaying (e.g., transmitting) the bid 40 by relaying the bid 40 via one or more wireless and/or wired networks 5.

In the same or different implementations, the bid relaying operation 504 may additionally or alternatively include or involve an operation 746 for relaying the bid by relaying the bid to one or more servers. For instance, the bid transmitting module 104* of the computing device 10* of FIG. 3A or 3B relaying the bid 40 by relaying the bid 40 to one or more network servers associated with, for example, one or more content providers.

In the same or different implementations, the bid relaying operation 504 may additionally or alternatively include or involve an operation 747 for relaying the bid that indicates at least the user elected fee amount by relaying a bid that indicates a user elected fee amount that was elected from a plurality of varying and indicated fee amounts. For instance, the bid transmitting module 104* of the computing device 10* of FIG. 3A or 3B relaying the bid 40 that indicates at least the user elected fee amount by relaying (e.g., transmitting) a bid 40 that indicates a user elected fee amount that was elected by a user 12 from a plurality of varying (e.g., graduated) and indicated fee amounts that were indicated through, for example, a GUI presented to the user 12.

In the same or different implementations, the bid relaying operation 504 may additionally or alternatively include or involve an operation 748 for relaying the bid that indicates at least the user elected fee amount by relaying a bid that indicates the user elected fee amount and a user elected amount of content access latency. For instance, the bid transmitting module 104* of the computing device 10* of FIG. 3A or 3B relaying the bid 40 that indicates at least the user elected fee amount by relaying a bid 40 that indicates the user elected fee amount and a user elected amount of content access latency as elected by, for example, a user 12.

In some cases, operation 748 may further include or involve an operation 749 for relaying a bid that indicates the user elected fee amount and the user elected amount of content access latency by relaying a bid that indicates the user elected fee amount and a user elected amount of content access latency that was elected from a plurality of varying amounts of content access latencies. For instance, the bid transmitting module 104* of the computing device 10* of FIG. 3A or 3B relaying a bid 40 that indicates the user elected fee amount and the user elected amount of content access latency by relaying a bid 40 that indicates the user elected fee amount and a user elected amount of content access latency that was elected by a user 12 from a plurality of varying amounts (e.g., tiered levels) of content access latencies that were presented through, for example, a GUI 200d (see FIG. 2D and feature 204d).

In the same or different implementations, the bid relaying operation 504 may additionally or alternatively include or involve an operation 750 for relaying the bid including relaying a bid that includes a request for accessing contextual information related to the content. For instance, the bid transmitting module 104* of the computing device 10* of FIG. 3A or 3B relaying the bid 40 including relaying a bid 40 that includes a request for accessing contextual information (e.g., historical market data, movie trailers, etc.) related to the content 20 (e.g., stock market or commodity prices, interest rate news, regulatory news, consumable media, etc.).

In the same or different implementations, the bid relaying operation 504 may additionally or alternatively include or involve an operation 751 for relaying the bid including relaying a bid that includes a request for accessing previous consumer information related to one or more users who have or who will have earlier access to the content than the access to the content obtained through the bid. For instance, the bid transmitting module 104* of the computing device 10* of FIG. 3A or 3B relaying the bid 40 including relaying a bid 40 that includes a request for accessing previous consumer information related to one or more users (e.g., other users 50) who have or who will have earlier access to the content 20 than the access to the content 20 obtained through the bid 40.

In the same or different implementations, the bid relaying operation 504 may additionally or alternatively include or involve an operation 752 for relaying the bid by relaying a bid that identifies the content. For instance, the bid transmitting module 104* of the computing device 10* of FIG. 3A or 3B relaying the bid 40 by relaying a bid 40 that identifies the content 20 (e.g., the bid 40 indicating that the content 20 is a particular type of news such as financial or market news, or indicating that the content 20 is consumable media such as a particular movie).

In the same or different implementations, the bid relaying operation 504 may additionally or alternatively include or involve an operation 753 for relaying the bid, at least in part, in response to obtaining the bid as the result of the soliciting by relaying the bid in response to obtaining a bid that was obtained using, at least in part, a visual channel. For instance, the bid transmitting module 104* of the computing device 10* of FIG. 3A or 3B relaying the bid 40, at least in part, in response to obtaining the bid 40 as the result of the soliciting by relaying the bid 40 in response to obtaining, by the bid obtaining module 103*, of a bid 40 that was obtained using, at least in part, a visual channel as provided through, for example, one or more visual devices (e.g., touchscreen or a liquid crystal display in combination with a keypad and/or mouse).

In some implementations, the bid relaying operation 504 may include or involve an operation 754 for relaying the bid, at least in part, in response to obtaining the bid as the result of the soliciting by relaying the bid in response to obtaining a bid that was obtained using, at least in part, an audio channel as illustrated in FIG. 7B. For instance, the bid transmitting module 104* of the computing device 10* of FIG. 3A or 3B relaying the bid 40, at least in part, in response to obtaining the bid 40 as the result of the soliciting by relaying the bid 40 in response to obtaining, by the bid obtaining module 103*, of a bid 40 that was obtained using, at least in part, an audio channel as provided through one or more audio devices (e.g., one or more speakers and one or more microphones).

In some implementations, the bid relaying operation 504 may include or involve an operation 755 for relaying the bid, at least in part, in response to obtaining the bid as the result of the soliciting by relaying the bid in response, at least in part, to obtaining a bid that was obtained using one or more input/output (I/O) devices. For instance, the bid transmitting module 104* of the computing device 10* of FIG. 3A or 3B relaying the bid 40, at least in part, in response to obtaining the bid 40 as the result of the soliciting by relaying the bid 40 in response, at least in part, to the bid obtaining module 103* obtaining a bid 40 that was obtained using one or more input/output (I/O) devices (e.g., one or more display monitors, speakers, keyboard, mouse, and/or other types of I/O devices).

In some implementations, the bid relaying operation 504 may include or involve an operation 756 for relaying the bid, at least in part, in response to obtaining the bid as the result of the soliciting by relaying the bid in response, at least in part, to obtaining a bid that was obtained through a graphical user interface (GUI) designed for submitting one or more bids. For instance, the bid transmitting module 104* of the computing device 10* of FIG. 3A or 3B relaying the bid 40, at least in part, in response to obtaining the bid 40 as the result of the soliciting by relaying (e.g., transmitting) the bid 40 in response, at least in part, to the bid obtaining module 103* obtaining a bid 40 that was obtained through a GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M) designed for submitting one or more bids 40.

In some implementations, operation 756 may further include or involve an operation 757 for relaying the bid in response, at least in part, to obtaining the bid that was obtained through a GUI designed for submitting the bid by relaying the bid in response, at least in part, to obtaining a user elected fee amount that was obtained through the GUI. For instance, the bid transmitting module 104* of the computing device 10* of FIG. 3A or 3B relaying the bid 40 in response, at least in part, to obtaining the bid 40 that was obtained through a GUI designed for submitting the bid 40 by relaying the bid 40 in response, at least in part, to the bid obtaining module 103 obtaining a user elected fee amount that was obtained through the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M).

In some implementations, operation 757 may further include an operation 758 for relaying the bid in response, at least in part, to obtaining the user elected fee amount that was obtained through the GUI by relaying the bid in response, at least in part, to obtaining a user elected fee amount that was entered through the GUI. For instance, the bid transmitting module 104* of the computing device 10* of FIG. 3A or 3B relaying the bid 40 in response, at least in part, to obtaining the user elected fee amount that was obtained through the GUI by relaying the bid 40 in response, at least in part, to the bid obtaining module 103* obtaining a user elected fee amount that was entered by a user 12 through the GUI (e.g., GUI 200a, 200b, 200c, 200d, 200e, 200f, 200g, 200h, 200i, 200k or 200m of FIG. 2A, 2B, 2C, 2D, 2E, 2F, 2G, 2H, 2I, 2K, or 2M).

In some implementations, operation 757 may further include an operation 759 for relaying the bid in response, at least in part, to obtaining the user elected fee amount that was obtained through the GUI by relaying the bid in response, at least in part, to obtaining a user elected fee amount that was selected from a plurality of varying fee amounts that was selectable through the GUI. For instance, the bid transmitting module 104* of the computing device 10* of FIG. 3A or 3B relaying the bid 40 in response, at least in part, to obtaining the user elected fee amount that was obtained through the GUI by relaying the bid 40 in response, at least in part, to the bid obtaining module 103* obtaining a user elected fee amount that was selected by a user 12 from a plurality of varying (e.g., graduated levels of) fee amounts, each of which were selectable (e.g., predefined fee amounts that are each electable) through the GUI (e.g., GUI 200c or 200d of FIG. 2C or 2D).

In some implementations, operation 756 may additionally or alternatively include or involve an operation 760 for relaying the bid in response, at least in part, to obtaining the user elected fee amount that was obtained through the GUI by relaying the bid in response, at least in part, to obtaining through the GUI a user elected amount of content access latency. For instance, the bid transmitting module 104* of the computing device 10* of FIG. 3A or 3B relaying the bid 40 in response, at least in part, to obtaining the user elected fee amount that was obtained through the GUI by relaying the bid 40 in response, at least in part, to the bid obtaining module 103* obtaining through the GUI 200b or 200d (see FIG. 2B or 2D) a user elected amount of content access latency.

As further illustrated in FIG. 7B, in some cases, operation 760 may include or involve an operation 761 for relaying the bid in response, at least in part, to obtaining through the GUI the user elected amount of content access latency by relaying the bid in response, at least in part, to obtaining a user elected amount of content access latency that was entered through the GUI. For instance, the bid transmitting module 104* of the computing device 10* of FIG. 3A or 3B relaying the bid 40 in response, at least in part, to obtaining through the GUI the user elected amount of content access latency by relaying the bid 40 in response, at least in part, to the bid obtaining module 103* obtaining a user elected amount of content access latency that was entered (e.g., inserted or inputted by a user 12) through the GUI 200b (see FIG. 2B and see also feature 204b, which allows a user 12 to enter an amount of content access latency).

In some cases, operation 760 may include or involve an operation 762 for relaying the bid in response, at least in part, to obtaining through the GUI the user elected amount of content access latency by relaying the bid in response, at least in part, to obtaining a user elected amount of content access latency that was selected from a plurality of varying amounts of content access latencies selectable through the GUI. For instance, the bid transmitting module 104* of the computing device 10* of FIG. 3A or 3B relaying the bid 40 in response, at least in part, to obtaining through the GUI the user elected amount of content access latency by relaying the bid 40 in response, at least in part, to the bid obtaining module 103* obtaining a user elected amount of content access latency that was selected from a plurality of varying amounts of content access latencies selectable (e.g., predefined content access latencies any of which are electable) through the GUI 200d (see FIG. 2D and see also feature 204d, which allows a user 12 to select or elect an amount of content access latency from a plurality of varying amounts of content access latencies).

In some cases, a user 12 may be allowed to submit multiple elections of multiple user elected fee amounts for, for example, multiple content access latencies. Such implementations may be particularly useful in cases, where, for example, the first election or option of a user 12 is not granted or accepted by the content provider because only a limited number of highest bidders are being granted earlier access to the content 20 by the content provider. Thus, in some implementations, the bid relaying operation 504 of FIG. 5 may actually include or involve an operation 763 for relaying the bid by relaying a bid that indicates the user elected fee amount associated with the specific amount of content access latency and that further indicates a second user elected fee amount associated with a second specific amount of content access latency, the user elected fee amount and the specific amount of content access latency being a first user elected fee amount and a first amount of content access latency, respectively, and the first user elected fee amount and the first amount of content access latency being a preferred election over the second user elected fee amount and the second amount of content access latency as illustrated in FIG. 7C. For instance, the bid transmitting module 104* of the computing device 10* of FIG. 3A or 3B relaying the bid 40 by relaying a bid 40 that indicates the user elected fee amount associated with the specific amount of content access latency and that further indicates a second user elected fee amount associated with a second specific amount of content access latency, the user elected fee amount and the specific amount of content access latency being a first user elected fee amount and a first amount of content access latency, respectively, and the first user elected fee amount and the first amount of content access latency being a preferred (e.g., a higher priority) election over the second user elected fee amount and the second amount of content access latency. FIGS. 2E and 2F illustrate exemplary GUI 200e and GUI 200f in accordance with some embodiments for electing multiple user elected fee amounts for multiple user elected content access latencies. Note that the phrase “preferred” as used herein is not in reference to any emotional or mental state associated with a user 12 but instead is in reference to, for example, a particular user election (e.g., an election of a particular user elected fee amount/content access latency) being designated for priority accepted/fulfillment before one or more other user elections are accepted/fulfilled.

As further illustrated in FIG. 7C, operation 763 may include one or more additional operations in various alternative implementations including, in some implementations, an operation 764 for relaying the bid that indicates the first user elected fee amount associated with the first content access latency and the second user elected fee amount associated with the second content access latency by relaying a bid that indicates at least a first user elected fee amount associated with a first user elected content access latency and a second user elected fee amount associated with a second user elected content access latency, the first user elected content access latency and the second user elected content access latency having been elected by a user. For instance, the bid transmitting module 104* of the computing device 10* of FIG. 3A or 3B relaying the bid 40 that indicates the first user elected fee amount associated with the first content access latency and the second user elected fee amount associated with the second content access latency by relaying a bid 40 (e.g., a bid 40 as entered by a user 12 using GUI 200F of FIG. 2F) that indicates at least a first user elected fee amount associated with a first user elected content access latency (see, for example, feature 221f for entering a first user elected fee amount and text 241f that indicates a first content access latency in the exemplary GUI 200f of FIG. 2F) and a second user elected fee amount associated with a second user elected content access latency (see, for example, feature 222f for entering a second user elected fee amount and text 242f that indicates a second content access latency in the exemplary GUI 200f of FIG. 2F), the first user elected content access latency and the second user elected content access latency having been elected by a user 12.

In some implementations, operation 763 may include an operation 765 for relaying the bid that indicates the first user elected fee amount associated with the first content access latency and the second user elected fee amount associated with the second content access latency by relaying a bid that further indicates a third user elected fee amount associated with a third content access latency, the first user elected fee amount associated with the first content access latency and the second user elected fee amount associated with the second content access latency being preferred elections over the third user elected fee amount associated with the third content access latency. For instance, the bid transmitting module 104* of the computing device 10* of FIG. 3A or 3B relaying the bid 40 that indicates the first user elected fee amount associated with the first content access latency and the second user elected fee amount associated with the second content access latency by relaying a bid 40 that further indicates a third user elected fee amount associated with a third content access latency, the first user elected fee amount associated with the first content access latency (see, for example, feature 221e for entering a first user elected fee amount and feature 231e for entering a first content access latency in the exemplary GUI 200e of FIG. 2E) and the second user elected fee amount associated with the second content access latency (see, for example, feature 222e for entering a second user elected fee amount and feature 232e for entering a second content access latency in the exemplary GUI 200e of FIG. 2E) being preferred elections over the third user elected fee amount associated with the third content access latency (see, for example, feature 223e for entering a third user elected fee amount and feature 233e for entering a third content access latency in the exemplary GUI 200e of FIG. 2E).

In some implementations, operation 765 may further include an operation 766 for relaying the bid that indicates the first user elected fee amount associated with the first content access latency, the second user elected fee amount associated with the second content access latency, and the third elected fee amount associated with the third content access latency by relaying a bid that indicates the first user elected fee amount associated with a first user elected content access latency, the second user elected fee amount associated with a second user elected content access latency, and the third elected fee amount associated with a third user elected content access latency, the first user elected content access latency, the second user elected content access latency, and the third user elected content access latency having been elected by a user. For instance, the bid transmitting module 104* of the computing device 10* of FIG. 3A or 3B relaying the bid 40 that indicates the first user elected fee amount associated with the first content access latency, the second user elected fee amount associated with the second content access latency, and the third elected fee amount associated with the third content access latency by relaying a bid 40 (e.g., as obtained through GUI 200e or GUI 200f of FIG. 2E or 2F) that indicates the first user elected fee amount associated with a first user elected content access latency, the second user elected fee amount associated with a second user elected content access latency, and the third elected fee amount associated with a third user elected content access latency, the first user elected content access latency, the second user elected content access latency, and the third user elected content access latency having been elected by a user 12.

In some cases, operation 763 may include an operation 767 for relaying the bid that indicates the first user elected fee amount associated with the first content access latency and the second user elected fee amount associated with the second content access latency by relaying a bid that indicates at least a first user elected fee amount associated with a first content access latency and a second user elected fee amount associated with a second content access latency, the first user elected fee amount and the second user elected fee amount having been entered by the user through a graphical user interface (GUI) designed for submitting the bid. For instance, the bid transmitting module 104* of the computing device 10* of FIG. 3A or 3B relaying the bid 40 that indicates the first user elected fee amount associated with the first content access latency and the second user elected fee amount associated with the second content access latency by relaying a bid 40 that indicates at least a first user elected fee amount associated with a first content access latency and a second user elected fee amount associated with a second content access latency, the first user elected fee amount and the second user elected fee amount having been entered by the user through a GUI 200e or 200f (see FIG. 2E or 2F) designed for submitting the bid 40.

Referring back to the content access acquiring operation 506 of FIG. 5, the content access acquiring operation 506 similar to the interface presenting operation 502 and the bid relaying operation 504 of FIG. 5 may be executed in a number of different ways in various alternative embodiments as illustrated in FIGS. 8A and 8B. In some implementations, for example, the content access acquiring operation 506 may include an operation 868 for acquiring at least the access to the content by acquiring access to the content via one or more wireless and/or wired networks as illustrated in FIG. 8A. For instance, the content access obtaining module 106* of the computing device 10* of FIG. 3A or 3B acquiring at least the access to the content 20 by acquiring (e.g., obtaining) access to the content 20 via one or more wireless and/or wired networks 5.

In the same or different implementations, the content access acquiring operation 506 may additionally or alternatively include or involve an operation 869 for acquiring at least the access to the content by acquiring a link for accessing the content. For instance, the content access obtaining module 106* including the link obtaining module 406 (see FIG. 4B) of the computing device 10* of FIG. 3A or 3B acquiring at least the access to the content 20 when the link obtaining module 406 acquires or obtains a link for accessing the content 20.

In some cases, operation 869 may further include or involve an operation 870 for acquiring the link for accessing the content by acquiring a hyperlink for accessing the content. For instance, the link obtaining module 406 of the computing device 10* of FIG. 3A or 3B acquiring the link for accessing the content 20 by acquiring a hyperlink for accessing the content 20.

In the same or different implementations, the content access acquiring operation 506 may additionally or alternatively include or involve an operation 871 for acquiring at least the access to the content by acquiring the content. For instance, the content access obtaining module 106* including the content obtaining module 408 (see FIG. 4B) of the computing device 10* of FIG. 3A or 3B acquiring at least the access to the content 20 when the content obtaining module 408 acquires or obtains the content 20.

Turning now to FIG. 8B, in the same or different implementations, the content access acquiring operation 506 of FIG. 5 may additionally or alternatively include or involve 872 for acquiring at least the access to the content by acquiring at least the access to the content only after the specific amount of content access latency has lapsed. For instance, the content access obtaining module 106* of the computing device 10* of FIG. 3A or 3B acquiring at least the access to the content 20 by acquiring (e.g., obtaining) at least the access to the content 20 only after the specific amount of content access latency has lapsed.

In some implementations, operation 872 may further include an operation 873 for acquiring at least the access to the content only after the specific amount of content access latency has lapsed by acquiring at least the access to the content only after the specific amount of content access latency has lapsed following a specified point in time. For instance, the content access obtaining module 106* of the computing device 10* of FIG. 3A or 3B acquiring at least the access to the content 20 only after the specific amount of content access latency has lapsed by acquiring at least the access to the content 20 only after the specific amount of content access latency has lapsed following a specified point in time (e.g., the earliest point in time in which a content 20 such as financial or market data becomes available to at least selective users, or the theatrical release date of a movie). In some cases, the point in time may be specified by a bidding tag 30 received by the computing device 10* or through a GUI (e.g., GUI 200a or 200b of FIG. 2A or 2B) used to solicit/elicit a bid 40 from the user 12.

In some cases, the content access acquiring operation 506 may additionally or alternatively include or involve an operation 874 for acquiring at least the access to the content by acquiring the access to the content prior to the lapse of the specific amount of content access latency and acquiring one or more instructions for providing access to the content only after the specific amount of content access latency has lapsed. For instance, the content access obtaining module 106* including the access releasing instruction obtaining module 410 (see FIG. 4B) of the computing device 10* of FIG. 3A or 3B acquiring at least the access to the content 20 by acquiring the access to the content 20 prior to the lapse of the specific amount of content access latency and acquiring, by the access releasing instruction obtaining module 410, of one or more instructions for providing access to the content 20 only after the specific amount of content access latency has lapsed.

In the same or alternative implementations, the content access acquiring operation 506 may additionally or alternatively include or involve an operation 875 for acquiring at least the access to the content including acquiring at least access to contextual information related to the content. For instance, the content access obtaining module 106* including the contextual information access obtaining module 412 (see FIG. 4B) of the computing device 10* of FIG. 3A or 3B acquiring at least the access to the content 20 including acquiring or obtaining, by the contextual information access obtaining module 412, of at least access to contextual information (e.g., historical market or financial data, historical commodity prices, movie trailers, etc.) related to the content 20.

In the same or alternative implementations, the content access acquiring operation 506 may additionally or alternatively include or involve an operation 876 for acquiring at least the access to the content including acquiring at least access to previous consumer information related to one or more users who have previously accessed the content. For instance, the content access obtaining module 106* including the previous consumer information access obtaining module 414 (see FIG. 4B) of the computing device 10* of FIG. 3A or 3B acquiring at least the access to the content 20 including acquiring, by the previous consumer information access obtaining module 414, of at least access to previous consumer information (e.g., number of other users 50 who have previous accessed the content 20, their identities, and so forth) related to one or more other users 50 who have previously accessed the content 20.

Referring back to the content access presenting operation 508 of FIG. 5, the content access presenting operation 508 similar to the interface presenting operation 502, the bid relaying operation 504, and the content access acquiring operation 506 of FIG. 5 may be executed in a number of different ways in various alternative embodiments as illustrated in FIGS. 9A and 9B. For example, in some implementations, the content access presenting operation 508 may include an operation 977 for presenting at least the access to the content by visually and/or audibly presenting the content as illustrated in FIG. 9A. For instance, the content access providing module 108* including the content providing module 416 (see FIG. 4C) of the computing device 10* of FIG. 3A or 3B presenting at least the access to the content 20 by visually and/or audibly presenting the content 20 (e.g., presenting the content 20 via one or more audio and/or visual devices such as one or more display devices, speakers, and so forth).

In the same or alternative implementations, the content access presenting operation 508 may additionally or alternatively include an operation 978 for presenting at least the access to the content by presenting at least the access to the content only after the specific amount of content access latency has lapsed. For instance, the content access providing module 108* of the computing device 10* of FIG. 3A or 3B presenting at least the access to the content 20 by presenting (e.g., providing) at least the access to the content 20 only after the specific amount of content access latency has lapsed.

In some implementations, operation 978 may further include an operation 979 for presenting at least the content only after the specific amount of content access latency has lapsed by presenting at least the access to the content only after the specific amount of content access latency has lapsed following a specified point in time. For instance, the content access providing module 108* of the computing device 10* of FIG. 3A or 3B presenting at least the content 20 only after the specific amount of content access latency has lapsed by presenting at least the access to the content 20 only after the specific amount of content access latency has lapsed following a specified point in time (e.g., the earliest point in time in which the content 20 can be made accessible).

In the same or alternative implementations, the content access presenting operation 508 may additionally or alternatively include an operation 980 for presenting at least the access to the content by presenting at least access to news content. For instance, the content access providing module 108* including the news content access providing module 418 (see FIG. 4C) of the computing device 10* of FIG. 3A or 3B presenting at least the access to the content 20 when the news content access providing module 418 presents (e.g., provides) at least access to news content.

In some implementations, operation 980 may further include or involve an operation 981 for presenting at least the access to the news content by presenting at least access to business, financial, and/or market news content. For instance, the news content access providing module 418 (see FIG. 4C) of the computing device 10* of FIG. 3A or 3B presenting at least the access to the news content by presenting at least access to business, financial, and/or market news content (e.g., prices of one or more stocks on a particular day, price of one or more commodities, financial information related to a publically traded company, production reports, and so forth).

In some implementations, operation 980 may alternatively or additionally include or involve an operation 982 for presenting at least the access to the news content by presenting at least access to human interest news content. For instance, the news content access providing module 418 (see FIG. 4C) of the computing device 10* of FIG. 3A or 3B presenting at least the access to the news content by presenting at least access to human interest news content (e.g., celebrity news, news related to a societal event, news related to natural disaster, news related to weather-related events, and so forth).

In some implementations, operation 980 may alternatively or additionally include or involve an operation 983 for presenting at least the access to the news content by presenting at least access to political, governmental, and/or regulatory news content. For instance, the news content access providing module 418 (see FIG. 4C) of the computing device 10* of FIG. 3A or 3B presenting at least the access to the news content by presenting at least access to political, governmental, and/or regulatory news content (e.g., new interest rates, regulatory announcements, and so forth).

Referring now to FIG. 9B, in various implementations, the content access presenting operation 508 may additionally or alternatively include an operation 984 for presenting at least the access to the content by presenting at least access to consumable media. For instance, the content access providing module 108* including the consumable media access providing module 420 (see FIG. 4C) of the computing device 10* of FIG. 3A or 3B presenting at least the access to the content 20 when the consumable media access providing module 420 presents (e.g., provides) at least access to consumable media.

As further illustrate in FIG. 9B, in some implementations, operation 984 may further include an operation 985 for presenting at least the access to consumable media by presenting at least access to at least one of a textual document, a video recording, a movie, or an audio recording. For instance, the consumable media access providing module 420 (see FIG. 4C) of the computing device 10* of FIG. 3A or 3B presenting at least the access to consumable media by presenting at least access to at least one of textual document, a video recording, a movie, or an audio recording.

In various implementations, the content access presenting operation 508 may additionally or alternatively include an operation 986 for presenting at least the access to the content including presenting at least access to contextual information related to the content. For instance, the content access providing module 108* including the contextual information access providing module 422 (see FIG. 4C) of the computing device 10* of FIG. 3A or 3B presenting at least the access to the content 20 including presenting (e.g., providing), by the contextual information access providing module 422, of at least access to contextual information (e.g., historical information, movie trailers, and so forth) related to the content 20.

In some implementations, operation 986 may further include an operation 987 for presenting at least the access to the contextual information related to the content by presenting at least access to historical background information associated with the content. For instance, the contextual information access providing module 422 of the computing device 10* of FIG. 3A or 3B presenting at least the access to the contextual information related to the content 20 by presenting at least access to historical background information (e.g., historical market information or historical commodity pricing) associated with the content 20.

In various implementations, the content access presenting operation 508 may additionally or alternatively include an operation 988 for presenting at least the access to the content including presenting at least access to previous consumer information related to one or more users who have previously accessed the content. For instance, the content access providing module 108* including the previous consumer information access providing module 424 (see FIG. 4C) of the computing device 10* of FIG. 3A or 3B presenting at least the access to the content 20 including presenting (e.g., providing), by the previous consumer information access providing module 424, of at least access to previous consumer information 22 related to one or more other users 50 who have previously accessed the content 20.

In some implementations, operation 988 may further include or involve an operation 989 for presenting at least the access to the previous consumer information by presenting at least access to information that identifies the one or more users who have previously accessed the content and/or the number of one or more users who have previously accessed the content. For instance, the previous consumer information access providing module 424 of the computing device 10* of FIG. 3A or 3B presenting at least the access to the previous consumer information 22 by presenting at least access to information that identifies the one or more other users 50 who have previously accessed the content 20 and/or the number of one or more other users 50 who have previously accessed the content 20.

In some implementations, operation 988 may further include or involve an operation 990 for presenting at least the access to the previous consumer information by presenting at least access to information that indicates when and/or how the one or more users who have previously accessed the content actually accessed the content. For instance, the previous consumer information access providing module 424 of the computing device 10* of FIG. 3A or 3B presenting at least the access to the previous consumer information 22 by presenting at least access to information that indicates when and/or how (e.g., the bandwidth or network used to access the content 20) the one or more users (e.g., other users 50 of FIG. 1) who have previously accessed the content 20 actually accessed the content 20.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinct ion left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency;
relaying the bid in response, at least in part, to obtaining the bid as a result of the soliciting, the bid to be relayed indicating at least the user elected fee amount;
acquiring at least access to the content as a result, at least in part, of the relaying; and
presenting at least the access to the content following lapse of the specific amount of content access latency.

2.-90. (canceled)

91. A computationally-implemented system, comprising:
means for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency;
means for relaying the bid in response, at least in part, to obtaining the bid as a result of the soliciting, the bid to be relayed indicating at least the user elected fee amount;
means for acquiring at least access to the content as a result, at least in part, of the relaying; and
means for presenting at least the access to the content following lapse of the specific amount of content access latency.

92.-95. (canceled)

96. The computationally-implemented system of claim 91, wherein said means for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency comprises:
means for presenting the interface for soliciting the bid by presenting an interface that is a channel for requesting submission of the bid, the requested bid to include at least the at least one user elected fee amount.

97. The computationally-implemented system of claim 96, wherein said means for presenting the interface for soliciting the bid by presenting an interface that is a channel for requesting submission of the bid, the requested bid to include at least the at least one user elected fee amount comprises:
means for presenting the interface that is the channel for requesting submission of the bid by presenting an interface that is a channel for requesting submission of the bid and for receiving the bid.

98. The computationally-implemented system of claim 91, wherein said means for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency comprises:
means for presenting an interface for soliciting the bid by presenting a graphical user interface (GUI) for submitting one or more bids.

99. The computationally-implemented system of claim 98, wherein said means for presenting an interface for soliciting the bid by presenting a graphical user interface (GUI) for submitting one or more bids comprises:
means for presenting the GUI for submitting the one or more bids by presenting a GUI that includes at least one feature for electing the user elected fee amount.

100. The computationally-implemented system of claim 99, wherein said means for presenting the GUI for submitting the one or more bids by presenting a GUI that includes at least one feature for electing the user elected fee amount comprises:
means for presenting the GUI that includes at least the one feature for electing the user elected fee amount by presenting a GUI that includes at least one feature for entering the user elected fee amount.

101. The computationally-implemented system of claim 99, wherein said means for presenting the GUI for submitting the one or more bids by presenting a GUI that includes at least one feature for electing the user elected fee amount comprises:
means for presenting the GUI that includes at least the one feature for electing the user elected fee amount by presenting a GUI that includes at least one feature for selecting the user elected fee amount from a plurality of varying fee amounts that are selectable through the at least one feature.

102. (canceled)

103. (canceled)

104. The computationally-implemented system of claim 98, wherein said means for presenting an interface for soliciting the bid by presenting a graphical user interface (GUI) for submitting one or more bids comprises:
means for presenting the GUI for submitting the one or more bids by presenting a GUI that includes at least one feature for electing the specific amount of content access latency.

105. The computationally-implemented system of claim 104, wherein said means for presenting the GUI for submitting the one or more bids by presenting a GUI that includes at least one feature for electing the specific amount of content access latency comprises:
means for presenting the GUI that includes at least the one feature for electing the specific amount of content access latency by presenting a GUI that includes at least one feature for selecting the specific amount of content access latency from a plurality of varying amounts of content access latencies.

106. (canceled)

107. The computationally-implemented system of claim 104, wherein said means for presenting the GUI for submitting the one or more bids by presenting a GUI that includes at least one feature for electing the specific amount of content access latency comprises:
means for presenting the GUI that includes at least the one feature for electing the specific amount of content access latency by presenting a GUI that includes at least one feature for entering the specific amount of content access latency.

108. The computationally-implemented system of claim 98, wherein said means for presenting an interface for soliciting the bid by presenting a graphical user interface (GUI) for submitting one or more bids comprises:
means for presenting the GUI for submitting the one or more bids by presenting a GUI that includes at least a first feature for electing the user elected fee amount and a second feature for electing the specific amount of content access latency.

109. (canceled)

110. The computationally-implemented system of claim 108, wherein said means for presenting the GUI for submitting the one or more bids by presenting a GUI that includes at least a first feature for electing the user elected fee amount and a second feature for electing the specific amount of content access latency comprises:
means for presenting the GUI that includes at least the first feature for electing the user elected fee amount and the second feature for electing the specific amount of content access latency by presenting a GUI that includes at least a first feature for selecting the user elected fee amount from a plurality of varying fee amounts that are selectable through the first feature and a second feature for selecting the specific amount of content access latency from a plurality of varying amounts of content access latencies.

111.-123. (canceled)

124. The computationally-implemented system of claim 98, wherein said means for presenting an interface for soliciting the bid by presenting a graphical user interface (GUI) for submitting one or more bids comprises:
means for presenting the GUI for submitting the one or more bids by presenting a GUI for submitting at least one bid and that provides access to previous consumer information related to one or more users who have previously accessed the content.

125. (canceled)

126. (canceled)

127. The computationally-implemented system of claim 124, wherein said means for presenting the GUI for submitting the one or more bids by presenting a GUI for submitting at least one bid and that provides access to previous consumer information related to one or more users who have previously accessed the content comprises:
means for presenting the GUI for submitting the at least one bid and that provides the access to the previous consumer information related to the one or more users who have previously accessed the content by presenting a GUI for submitting the at least one bid and that provides access to previous consumer information that identifies the one or more users who have previously accessed the content and/or the number of one or more users who have previously accessed the content.

128. The computationally-implemented system of claim 124, wherein said means for presenting the GUI for submitting the one or more bids by presenting a GUI for submitting at least one bid and that provides access to previous consumer information related to one or more users who have previously accessed the content comprises:
means for presenting the GUI for submitting the at least one bid and that provides the access to the previous consumer information related to the one or more users who have previously accessed the content by presenting a GUI for submitting the at least one bid and that provides access to previous consumer information that indicates when and/or how the one or more users who have previously accessed the content actually accessed the content.

129.-137. (canceled)

138. The computationally-implemented system of claim 91, wherein said means for relaying the bid in response, at least in part, to obtaining the bid as a result of the soliciting, the bid to be relayed indicating at least the user elected fee amount comprises:
means for relaying the bid that indicates at least the user elected fee amount by relaying a bid that indicates the user elected fee amount and a user elected amount of content access latency.

139. The computationally-implemented system of claim 138, wherein said means for relaying the bid that indicates at least the user elected fee amount by relaying a bid that indicates the user elected fee amount and a user elected amount of content access latency comprises:
means for relaying a bid that indicates the user elected fee amount and the user elected amount of content access latency by relaying a bid that indicates the user elected fee amount and a user elected amount of content access latency that was elected from a plurality of varying amounts of content access latencies.

140. (canceled)

141. The computationally-implemented system of claim 91, wherein said means for relaying the bid in response, at least in part, to obtaining the bid as a result of the soliciting, the bid to be relayed indicating at least the user elected fee amount comprises:
means for relaying the bid including relaying a bid that includes a request for accessing previous consumer information related to one or more users who have or who will have earlier access to the content than the access to the content obtained through the bid.

142.-145. (canceled)

146. The computationally-implemented system of claim 91, wherein said means for relaying the bid in response, at least in part, to obtaining the bid as a result of the soliciting, the bid to be relayed indicating at least the user elected fee amount comprises:
means for relaying the bid, at least in part, in response to obtaining the bid as the result of the soliciting by relaying the bid in response, at least in part, to obtaining a bid that was obtained through a graphical user interface (GUI) designed for submitting one or more bids.

147.-149. (canceled)

150. The computationally-implemented system of claim 146, wherein said means for relaying the bid, at least in part, in response to obtaining the bid as the result of the soliciting by relaying the bid in response, at least in part, to obtaining a bid that was obtained through a graphical user interface (GUI) designed for submitting one or more bids comprises:
means for relaying the bid in response, at least in part, to obtaining the user elected fee amount that was obtained through the GUI by relaying the bid in response, at least in part, to obtaining through the GUI a user elected amount of content access latency.

151. (canceled)

152. The computationally-implemented system of claim 150, wherein said means for relaying the bid in response, at least in part, to obtaining the user elected fee amount that was obtained through the GUI by relaying the bid in response, at least in part, to obtaining through the GUI a user elected amount of content access latency comprises:
means for relaying the bid in response, at least in part, to obtaining through the GUI the user elected amount of content access latency by relaying the bid in response, at least in part, to obtaining a user elected amount of content access latency that was selected from a plurality of varying amounts of content access latencies selectable through the GUI

153. The computationally-implemented system of claim 91, wherein said means for relaying the bid in response, at least in part, to obtaining the bid as a result of the soliciting, the bid to be relayed indicating at least the user elected fee amount comprises:
means for relaying the bid by relaying a bid that indicates the user elected fee amount associated with the specific amount of content access latency and that further indicates a second user elected fee amount associated with a second specific amount of content access latency, the user elected fee amount and the specific amount of content access latency being a first user elected fee amount and a first amount of content access latency, respectively, and the first user elected fee amount and the first amount of content access latency being a preferred election over the second user elected fee amount and the second amount of content access latency.

154. The computationally-implemented system of claim 153, wherein said means for relaying the bid by relaying a bid that indicates the user elected fee amount associated with the specific amount of content access latency and that further indicates a second user elected fee amount associated with a second specific amount of content access latency, the user elected fee amount and the specific amount of content access latency being a first user elected fee amount and a first amount of content access latency, respectively, and the first user elected fee amount and the first amount of content access latency being a preferred election over the second user elected fee amount and the second amount of content access latency comprises:
means for relaying the bid that indicates the first user elected fee amount associated with the first content access latency and the second user elected fee amount associated with the second content access latency by relaying a bid that indicates at least a first user elected fee amount associated with a first user elected content access latency and a second user elected fee amount associated with a second user elected content access latency, the first user elected content access latency and the second user elected content access latency having been elected by a user.

155. The computationally-implemented system of claim 153, wherein said means for relaying the bid by relaying a bid that indicates the user elected fee amount associated with the specific amount of content access latency and that further indicates a second user elected fee amount associated with a second specific amount of content access latency, the user elected fee amount and the specific amount of content access latency being a first user elected fee amount and a first amount of content access latency, respectively, and the first user elected fee amount and the first amount of content access latency being a preferred election over the second user elected fee amount and the second amount of content access latency comprises:
means for relaying the bid that indicates the first user elected fee amount associated with the first content access latency and the second user elected fee amount associated with the second content access latency by relaying a bid that further indicates a third user elected fee amount associated with a third content access latency, the first user elected fee amount associated with the first content access latency and the second user elected fee amount associated with the second content access latency being preferred elections over the third user elected fee amount associated with the third content access latency.

156.-161. (canceled)

162. The computationally-implemented system of claim 91, wherein said means for acquiring at least access to the content as a result, at least in part, of the relaying comprises:
means for acquiring at least the access to the content by acquiring at least the access to the content only after the specific amount of content access latency has lapsed.

163. The computationally-implemented system of claim 162, wherein said means for acquiring at least the access to the content by acquiring at least the access to the content only after the specific amount of content access latency has lapsed comprises:
means for acquiring at least the access to the content only after the specific amount of content access latency has lapsed by acquiring at least the access to the content only after the specific amount of content access latency has lapsed following a specified point in time.

164. The computationally-implemented system of claim 91, wherein said means for acquiring at least access to the content as a result, at least in part, of the relaying comprises:
means for acquiring at least the access to the content by acquiring the access to the content prior to the lapse of the specific amount of content access latency and acquiring one or more instructions for providing access to the content only after the specific amount of content access latency has lapsed.

165. (canceled)

166. The computationally-implemented system of claim 91, wherein said means for acquiring at least access to the content as a result, at least in part, of the relaying comprises:
means for acquiring at least the access to the content including acquiring at least access to previous consumer information related to one or more users who have previously accessed the content.

167. (canceled)

168. The computationally-implemented system of claim 91, wherein said means for said presenting at least the access to the content following lapse of the specific amount of content access latency comprises:
means for presenting at least the access to the content by presenting at least the access to the content only after the specific amount of content access latency has lapsed.

169. The computationally-implemented system of claim 168, wherein said means for presenting at least the access to the content by presenting at least the access to the content only after the specific amount of content access latency has lapsed comprises:
means for presenting at least the content only after the specific amount of content access latency has lapsed by presenting at least the access to the content only after the specific amount of content access latency has lapsed following a specified point in time.

170. The computationally-implemented system of claim 91, wherein said means for said presenting at least the access to the content following lapse of the specific amount of content access latency comprises:
means for presenting at least the access to the content by presenting at least access to news content.

171. The computationally-implemented system of claim 170, wherein said means for presenting at least the access to the content by presenting at least access to news content comprises:
means for presenting at least the access to the news content by presenting at least access to business, financial, and/or market news content.

172. (canceled)

173. The computationally-implemented system of claim 170, wherein said means for presenting at least the access to the content by presenting at least access to news content comprises:
means for presenting at least the access to the news content by presenting at least access to political, governmental, and/or regulatory news content.

174. The computationally-implemented system of claim 91, wherein said means for said presenting at least the access to the content following lapse of the specific amount of content access latency comprises:
means for presenting at least the access to the content by presenting at least access to consumable media.

175.-177. (canceled)

178. The computationally-implemented system of claim 91, wherein said means for said presenting at least the access to the content following lapse of the specific amount of content access latency comprises:
means for presenting at least the access to the content including presenting at least access to previous consumer information related to one or more users who have previously accessed the content.

179. The computationally-implemented system of claim 178, wherein said means for presenting at least the access to the content including presenting at least access to previous consumer information related to one or more users who have previously accessed the content comprises:
means for presenting at least the access to the previous consumer information by presenting at least access to information that identifies the one or more users who have previously accessed the content and/or the number of one or more users who have previously accessed the content.

180. The computationally-implemented system of claim 178, wherein said means for presenting at least the access to the content including presenting at least access to previous consumer information related to one or more users who have previously accessed the content comprises:
means for presenting at least the access to the previous consumer information by presenting at least access to information that indicates when and/or how the one or more users who have previously accessed the content actually accessed the content.

181. A system, comprising:
circuitry for presenting an interface for soliciting a bid for accessing a content following lapse of a specific amount of content access latency, the bid to be solicited including at least one user elected fee amount elected from a plurality of fee amounts available for election for the specific amount of content access latency, the user elected fee amount being an amount of fee being offered through the bid in exchange for accessing the content following lapse of the specific amount of content access latency;
circuitry for relaying the bid in response, at least in part, to obtaining the bid as a result of the soliciting, the bid to be relayed indicating at least the user elected fee amount;
circuitry for acquiring at least access to the content as a result, at least in part, of the relaying; and
circuitry for presenting at least the access to the content following lapse of the specific amount of content access latency.
